(19) United States
(12) Patent Application Publication
(10) Pub. No.: US 2002/0039264 A1
(43) Pub. Date: Apr. 4, 2002

(54) Yoke type magnetic head and magnetic disk unit

(75) Inventors: Yuichi Ohsawa, Yokohama-Shi (JP); Masatoshi Yoshikawa, Yokohama-Shi (JP); Michiko Hara, Yokohama-Shi (JP); Tomomi Funayama, Fujisawa-Shi (JP); Susumu Hashimoto, Ebina-Shi (JP); Kohichi Tateyama, Yokohama-Shi (JP); Hiroaki Yoda, Kawasaki-Shi (JP); Yuzo Kamiguchi, Yokohama-Shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Minato-Ku (JP)

(21) Appl. No.: 09/942,627

(22) Filed: Aug. 31, 2001

(30) Foreign Application Priority Data
Aug. 31, 2000 (JP) 2000-263818
Aug. 31, 2000 (JP) 2000-264006
Sep. 29, 2000 (JP) 2000-300660

(51) Int. Cl. G11B 5/39

(52) U.S. Cl. 360/322; 360/324.1; 360/324.2

(57) ABSTRACT

A yoke type magnetic head comprises a magnetoresistance effect film for sensing a signal magnetic field from a medium, a pair of magnetic yokes which are magnetically connected to the magnetoresistance effect film and which face each other via a magnetic gap, and a pair of electrodes which are connected to the magnetoresistance effect film so that a sense current in a thickness direction of the magnetoresistance effect film is applied thereto, one of the electrodes being formed in the magnetic gap. Thus, it is possible to prevent the lowering of the magnetic flux efficiency.

### BACKGROUND OF THE INVENTION

1. Field of The Invention

The present invention relates generally to a yoke type magnetic head and a magnetic disk unit having the yoke type magnetic head.

2. Description of Related Art

In recent years, the magnetic packing density of hard disk drive units (which will be also hereinafter referred to as HDDS) is rapidly improved, and it is desired to further enhance the packing density. Due to the scale down of a recording bit size according to the enhancement of the packing density, the regenerative sensitivity of conventional thin-film heads is not sufficient. Currently, magnetoresistance effect heads (which will be also hereinafter referred to as MR heads) utilizing the magnetoresistance effect are mainly used. As magnetoresistance effect heads having particularly great magnetoresistance effects, spin valve type giant magnetoresistance effect heads (which will be also hereinafter referred to as SV heads) are widely noticed.

On the other hand, in order to sense a small medium bit field due to the enhancement of the packing density, the flying height of a thin-film magnetic head during traveling is decreasing. In such a tendency for the flying height of a magnetic head during traveling to decrease, it is expected that it is not possible to prevent the magnetic head from traveling while intermittently or always contacting a storage medium. From a standpoint other than the enhancement of the packing density, it is also expected that HDDs are installed in audio visual apparatuses (which will be also hereinafter referred to as AV apparatuses) as multimedia is improved in the world in future. In the installation of HDDs in an AV apparatus, the reliability of the HDDs, particularly the resistance of the HDDs to impact from the outside, is important. In this case, it is considered that the magnetic head contacts the surface of the medium, so that it is desired to develop a magnetic head which is resistant to contact.

However, it is well known that the above-described conventional SV head exhibits the abnormal variation in resistance due to heat which is generated by the contact of the SV head with the storage medium (thermal asperity). Therefore, the conventional MR head and SV heads having a magneto-sensitive portion exposed to a medium facing surface can not be adapted to the enhancement of the packing density in future.

Therefore, various shapes of yoke type magnetic heads are proposed. The yoke type magnetic head is resistant to the above-described thermal asperity since the magneto-sensitive portion of the SV portion is exposed to the medium facing surface. Among such yoke type magnetic heads, a horizontal yoke type magnetic head wherein it is possible to shorten a magnetic path and it is easy to lighten a head slider is widely noticed.

From the standpoint of magnetoresistance effect elements (which will be also hereinafter referred to as MR elements), it is expected that it is very difficult to finely pattern current in plane type electrode structures in a fabrication process because of the rapid scale down in recent years, and current perpendicular to plane type MR elements wherein a current is applied in a direction perpendicular to the surface of a film (a thickness direction) are widely noticed. In recent years, as typical current perpendicular to plane type MR elements, there are tunneling GMR elements utilizing the tunnel effect of electrons exhibiting the super-giant magnetoresistance effect.

In view of the above-described tendency, a combination of a yoke type magnetic head with a current perpendicular to plane type MR element is considered. FIG. 64 is a sectional view of a conventional magnetoresistance effect magnetic head of a current perpendicular to plane type. As can be seen from FIG. 64, when a magnetoresistance effect film (MR film) 9 of a current perpendicular to plane type is used for a yoke type magnetic head, a leading electrode 6 and a bottom electrode 7 are provided between a magnetic yoke 3 and the MR film 9. Therefore, the thickness of a portion between the magnetic yoke 3 and the MR film 9 is greater than that of the conventional yoke type magnetic head by the thickness of the electrode 6, so that there is a problem in that the flow of a magnetic flux in the MR element portion is inhibited to lower a magnetic flux efficiency. Furthermore, in FIG. 64, reference number 4 denotes a magnetic gap, reference number 13 denotes a pillar portion for connecting a top electrode (not shown) to the MR film 9, and reference number 25 denotes an insulating film.

### SUMMARY OF THE INVENTION

It is therefore an object of the present invention to eliminate the aforementioned problems and to provide a yoke type magnetic head capable of preventing a magnetic flux efficiency, and a magnetic disk unit having the same.

In order to accomplish the aforementioned object, according to one aspect of the present invention, a yoke type magnetic head comprises: a magnetoresistance effect film sensing a signal magnetic field from a medium; a pair of magnetic yokes being magnetically connected to the magnetoresistance effect film and facing each other via a magnetic gap; and a pair of electrodes being connected to the magnetoresistance effect film so that a sense current in a thickness direction of the magnetoresistance effect film is applied thereto, one of the electrodes being formed in the magnetic gap.

In this yoke type magnetic head, the magnetoresistance effect film comprises a free layer, a pin layer, an antiferromagnetic layer for fixing magnetization of the pin layer, an underlayer, a cap layer, and a spacer layer sandwiched between the pin layer and the free layer, and the free layer is magnetically connected to the magnetic yokes. A magnetic circuit is formed by the pair of magnetic yokes and the free layer of the magnetoresistance effect element. The magnetoresistance effect layer and the magnetic yokes are sometimes magnetically connected to each other via a magnetic gap which is provided therebetween. In order to lower reluctance of the magnetic circuit, the magnetoresistance effect film, particularly the free layer, may overlap with the magnetic yokes. The magnetoresistance effect film may be formed in the magnetic gap which is formed by the magnetic yokes.

This yoke type magnetic head has a so-called CPP (Current perpendicular to plane) type magnetoresistance effect film in which an electrode is formed so that a current is applied in a direction perpendicular to the surface of the film (in a thickness direction). In the CPP type magnetoresistance effect film, even if the track width and bit length decrease due to the improvement of the packing density and even if the distance between electrodes decreases, it is possible to prevent the electrodes from being short-circuited, so that it is possible to stably obtain a high output, since the pair of electrodes are separately formed on the top and bottom faces of the film.

According to the magnetic head of the present invention with this construction, one of the electrodes is formed in the magnetic gap. Therefore, since the magnetic gap between the magnetoresistance effect film and the magnetic yokes can be smaller than that in conventional magnetic head, or since the magnetic gap can be omitted, the flow of a magnetic flux into the magnetoresistance effect film can be smooth, i.e., reluctance in the magnetic circuit formed by the magnetic yoke and the magnetoresistance effect film can be lowered, so that it is possible to prevent the lowering of the magnetic flux efficiency.

Each of the pair of magnetic yokes may have a flat portion which faces the magnetic gap and which is substantially parallel to a medium facing surface, and the magnetoresistance effect film may be formed on a plane which is substantially parallel to the medium facing surface.

With this construction, the distance (which will be hereinafter referred to as the depth) between the medium facing surface and the magnetoresistance effect film is controlled by the thickness of the magnetic yokes. Since the magnetic yokes are formed by the deposition of a film, the depth can be far smaller (to about 100 nm or less) and more precisely controlled than the conventional control of the depth by the polishing from the medium facing surface, so that it is possible to shorten the magnetic path.

The magnetoresistance effect film may be a current perpendicular to plane type giant magnetoresistance effect film.

The magnetoresistance effect film may be a tunneling magnetoresistance effect film.

With this construction, it is possible to reduce the influence of the magnetic field due to the current. In general, the tunneling magnetoresistance effect film has a higher resistance than that of a usual magnetoresistance effect film, so that it is possible to obtain a sufficient output voltage even if the sense current is small. In the case of the tunneling magnetoresistance effect film, the sense current density is about 10 MA/cm² or less. Therefore, the magnetic field based on the sense current can be small to have a small influence on the magnetoresistance effect film portion, so that it is possible to obtain a desired S/N (signal/noise) ratio.

The magnetic yokes may be electrically connected to the electrode formed in the magnetic gap.

With this construction, it is possible to reduce a local magnetic field caused by a current, and it is possible to lower the resistance of the electrodes.

According to another aspect of the present invention, a yoke type magnetic head comprises: a magnetoresistance effect film, formed on a plane substantially parallel to a medium facing surface, sensing a signal magnetic field from a medium; a pair of magnetic yokes facing each other via a magnetic gap, each of the pair of magnetic yokes having a flat portion which faces the magnetic gap and which is substantially parallel to a medium facing surface, the pair of magnetic yokes being electrically connected to the magnetoresistance effect film; and a pair of electrodes being electrically connected to the magnetoresistance effect film, the magnetic yokes being magnetically and electrically connected to the magnetoresistance effect film, and the magnetic yokes also serving as one of the pair of electrodes.

In this yoke type magnetic head, the magnetoresistance effect film comprises a free layer, a pin layer, an antiferromagnetic layer for fixing magnetization of the pin layer, an underlayer, a cap layer, and a spacer layer sandwiched between the pin layer and the free layer, and the free layer is magnetically connected to the magnetic yokes. A magnetic circuit is formed by the pair of magnetic yokes and the free layer of the magnetoresistance effect element. In order to lower reluctance of the magnetic circuit, the magnetoresistance effect film, particularly the free layer, may overlap with the magnetic yokes. The magnetoresistance effect film may be formed in the magnetic gap which is formed by the magnetic yokes.

According to the magnetic head of the present invention with this construction, the magnetic yokes and the magnetoresistance are electrically connected to each other, and the magnetic yokes are used as an electrode. Therefore, it is possible to omit an insulating film which is required to be formed between magnetic yokes and a magnetoresistance effect film in conventional heads, so that it is possible to lower reluctance between the magnetic yokes and the magnetoresistance effect film.

The magnetoresistance effect film may be formed so that a sense current in a thickness direction of the magnetoresistance effect film is applied thereto.

With this construction, even if the track width and bit length decrease due to the improvement of the packing density and even if the distance between electrodes decreases, it is possible to prevent the electrodes from being short-circuited, so that it is possible to stably obtain a high output, since the pair of electrodes are separately formed on the top and bottom faces of the film.

Furthermore, a non-magnetic electric conductor may be formed in the magnetic gap, and the electric conductor may be electrically connected to the magnetic yokes also serving as the electrode.

With this construction, the pair of magnetic yokes can completely have the same potential.

The magnetic yokes also serving as the electrode are preferably electrically grounded.

With this construction, it is possible to prevent the electrostatic breakdown of the magnetoresistance effect film due to static electricity which is mainly generated by the contact of a magnetic recording medium with the magnetic head.

The magnetoresistance effect film may be a tunneling magnetoresistance effect film. In general, the tunneling magnetoresistance effect film has a higher resistance than that of a usual magnetoresistance effect film, so that it is possible to obtain a sufficient output voltage even if the sense current is small. In the case of the tunneling magnetoresistance effect film, the sense current density is about 10 MA/cm² or less. Therefore, the galvano magnetic field based on the sense current can be small to have a small influence on the magnetoresistance effect film portion, so that it is possible to obtain a desired S/N (signal/noise) ratio.

According to another aspect of the present invention, a yoke type magnetic head comprises: a magnetoresistance effect film sensing a signal magnetic field from a medium; first and second magnetic yokes being magnetically connected to the magnetoresistance effect film and facing each other via a magnetic gap; and first and second electrodes being connected to the magnetoresistance effect film so that a sense current in a thickness direction of the magnetoresistance effect film is applied, the magnetoresistance effect film being formed so as to straddle the magnetic gap, the first electrode having a flat surface on the side of the magnetoresistance effect film, a contact area of the first electrode with the magnetoresistance effect film being defined by the area of the magnetoresistance effect film, and the area of the flat surface being greater than the contact area.

The first electrode means an electrode (which will be hereinafter referred to as a top electrode) on the far side from the medium facing surface viewed from the MR film, and the second electrode means an electrode (which will be hereinafter referred to as a bottom electrode) on the near side to the medium facing surface viewed from the MR film.

In the yoke type magnetic head of the present invention with the above described construction, the contact area is preferably smaller than the lowermost surface of the magnetoresistance effect film. Thus, the sense current can be concentrated in the signal magnetic field sensing region on the magnetic gap, so that it is possible to reduce noises in the output of the magnetic head. The lowermost surface means the bottom surface of the underlayer, i.e., a surface facing the magnetic yoke.

The magnetoresistance effect film may comprise a free layer, a pin layer, an antiferromagnetic layer for fixing magnetization of the pin layer, an underlayer, a cap layer and a spacer layer which is sandwiched between the pin layer and the free layer.

The area of each of at least the pin layer, the antiferromagnetic layer and the cap layer may be defined so as to be smaller than the area of the free layer, and the pin layer, the cap layer and the antiferromagnetic layer may be formed on the magnetic gap.

With this construction, the sense current can be applied to the signal magnetic field sensing region right above the magnetic gap, and the pin layer does not extend to the insensible region of the free layer, so that it is possible to greatly lower the noise level.

Furthermore, each of the first and second magnetic yokes may include a tip portion having a flat portion which faces the magnetic gap and which is substantially parallel to the medium facing surface, and a wing portion extending from a portion which is provided between the tip portion and the magnetoresistance effect film, the area of the flat portion of the magnetic yokes being smaller than the cross-sectional area of an arbitrary cross section of the magnetic yokes which are substantially parallel to a medium facing surface, the magnetic gap being formed between the medium facing surface and the formed surface of the magnetoresistance effect film, the size of the magnetic gap on the side of the formed surface of the magnetoresistance effect film being greater than the size of the magnetic gap on the side of the medium facing surface, and the formed surface of the magnetoresistance effect film being substantially parallel to the medium facing surface.

With this construction, i.e., by forming the magnetic head as a horizontal yoke type magnetic head, the shortest magnetic path can be formed in the yoke magnetic head. Moreover, in this structure, it is easy to form the overlapping portion of the free layer with the magnetic yokes, and it is possible to easily improve the magnetic flux efficiency.

Preferably, assuming that a center of a medium facing surface of the magnetic gap is a center of a coordinate axis, an axis extending in a track cross direction from the center of the coordinate axis is X-axis, an axis extending in a bit length direction from the center of the coordinate axis is Y-axis, the length of the pin layer in the track cross direction is Wp, the length of the pin layer in the bit length direction is Lp, the length of the magnetic yoke on the side of the medium facing surface in the X-axis direction is Wy1, the length of the magnetic yoke on the side of the formed surface of the magnetoresistance effect film in the X-axis direction is Wy3, and the length of the tip portion of the magnetic yoke on the side of the formed surface of the magnetoresistance effect film in the Y-axis direction is Ly2, then, an end portion of the pin layer in the track cross direction, which has an x-coordinate expressed by x=±Wp/2, is defined in a region which is beyond a range of an end portion of the tip portion of the magnetic yoke, which has an x-coordinate expressed by x=±(Wy1)/2, and which is within a range of an end portion of the magnetic yoke layer in the track cross direction, which has an x-coordinate expressed by x=±(Wy3)/2, and an end portion of the pin layer in the bit length direction, which has a y-coordinate expressed by y=±Lp/2, is defined in a region which is within a range of the end portion of the tip portion of the magnetic yoke, which has a y-coordinate expressed by y=±(Ly2)/2.

Preferably, assuming that a center of a medium facing surface of the magnetic gap is a center of a coordinate axis, an axis extending in a track cross direction from the center of the coordinate axis is X-axis, an axis extending in a bit length direction from the center of the coordinate axis is Y-axis, the length of the free layer in the track cross direction is Wf, the length of the free layer in the bit length direction is Lf, and the lengths of the tip portion of the magnetic yoke on the side of the formed portion of the magnetoresistance effect film in the X and Y directions are Wy2and Ly2, respectively, then, an end portion of the free layer in the track cross direction, which has an x-coordinate expressed by x=±Wf/2, is defined in a region which is beyond a range of x=±(Wy2)/2, and an end portion of the free layer in the bit length direction, which has a y-coordinate expressed by y=±Lf/2, is defined in a region which is beyond a range of y=±Ly2/2.

Preferably, the magnetoresistance effect film is electrically connected to the first and second magnetic yoke, and the second electrode is electrically connected to the magnetic yokes.

The bottom electrode is preferably formed so as to be electrically connected to the free layer.

According to a further aspect of the present invention, there is provided a method for fabricating a yoke type magnetic head having a magneto-sensitive layer having magnetization in the plane of the layer, the method comprising: forming a current perpendicular to plane type magnetoresistance effect film, in which a sense current flows in a direction perpendicular to the plane of the film, to pattern the film in an element shape; and

forming a magnetic yokes which covers the magnetoresistance effect film patterned in the element shape.

The method may further comprise forming a non-magnetic film for covering the magnetoresistance effect film patterned in the element shape, to pattern the non-magnetic film to form a magnetic gap in the magnetoresistance effect film, before forming the magnetic yoke.

The method may further comprise covering the magnetoresistance effect film patterned in the element shape, with a non-magnetic film to form a protruding portion, before forming the magnetic yoke, and the forming the magnetic yoke may cover the protruding portion with a magnetic film to form a magnetic gap in the magnetic film above the protruding portion.

In the yoke type magnetic head with this construction, the magnetoresistance effect film and the magnetic yoke are formed while being self-aligned, so that it is possible to prevent the position shift between the magnetoresistance effect film, the magnetic yoke and the magnetic gap. Moreover, the distances between the positions of the most proximate yokes and the center of the sense current are substantially equal to each other, and the galvano magnetic field induced by the sense current is symmetrical with respect to the magnetoresistance effect film. Thus, it is possible to inhibit the generation of magnetic domains into the magnetic yoke, so that it is possible to inhibit Barkhausen noises. It is also possible to prevent the lowering of yields.

The yoke type magnetic head according to the present invention may be fabricated by the above-described fabricating method.

According to a still further aspect of the present invention, a magnetic disk unit includes any one of the above described yoke type magnetic heads.

### BRIEF DESCRIPTION OF THE DRAWINGS

The present invention will be understood more fully from the detailed description given herebelow and from the accompanying drawings of the embodiments of the invention. However, the drawings are not intended to imply limitation of the invention to a specific embodiment, but are for explanation and understanding only.

In the drawings:

FIG. 1 is a sectional view showing the construction of the first embodiment of a yoke type magnetic head according to the present invention;

FIG. 2 is a construction drawing of components of the first embodiment wherein the sizes of the components are expressed;

FIG. 3 is a sectional view showing steps of fabricating the magnetic head in the first embodiment;

FIG. 4 is a sectional view showing steps of fabricating the magnetic head in the first embodiment;

FIG. 5 is a sectional view showing the construction of the second embodiment of a yoke type magnetic head according to the present invention;

FIG. 6 is a sectional view showing the construction of the third embodiment of a yoke type magnetic head according to the present invention;

FIG. 7 is a sectional view showing the construction of the fourth embodiment of a yoke type magnetic head according to the present invention;

FIG. 8 is a sectional view showing the construction of the fifth embodiment of a yoke type magnetic head according to the present invention;

FIG. 9 is a sectional view showing the construction of the sixth embodiment of a yoke type magnetic head according to the present invention;

FIG. 10 is a sectional view showing the construction of the seventh embodiment of a yoke type magnetic head according to the present invention;

FIG. 11 is a sectional view showing the construction of the eighth embodiment of a yoke type magnetic head according to the present invention;

FIG. 12 is a sectional view showing the construction of the ninth embodiment of a yoke type magnetic head according to the present invention;

FIG. 13 is a sectional view showing the construction of the tenth embodiment of a yoke type magnetic head according to the present invention;

FIG. 14 is a sectional view showing the construction of the eleventh embodiment of a yoke type magnetic head according to the present invention;

FIG. 15 is a sectional view showing the construction of the twelfth embodiment of a yoke type magnetic head according to the present invention;

FIG. 16 is a sectional view showing the construction of the thirteenth embodiment of a yoke type magnetic head according to the present invention;

FIG. 17 is a sectional view showing a modified example of the magnetic head in the thirteenth embodiment;

FIG. 18 is a sectional view showing a modified example of the magnetic head in the thirteenth embodiment;

FIG. 19 is a sectional view showing the construction of the fourteenth embodiment of a yoke type magnetic head according to the present invention;

FIG. 20 is a schematic diagram showing the construction of a conventional magnetic head;

FIG. 21 is a schematic diagram showing the construction of the fifteenth embodiment of a yoke type magnetic head according to the present invention;

FIG. 22 is a sectional view showing the construction of the sixteenth embodiment of a yoke type magnetic head according to the present invention;

FIG. 23 is a sectional view showing the construction of the seventeenth embodiment of a yoke type magnetic head according to the present invention;

FIG. 24 is a sectional view showing the construction of an MR element of the eighteenth embodiment of a yoke type magnetic head according to the present invention;

FIG. 25 is a sectional view showing the construction of the nineteenth embodiment of a yoke type magnetic head according to the present invention;

FIG. 26 is a sectional view showing the construction of the twentieth embodiment of a yoke type magnetic head according to the present invention;

FIG. 27 is a sectional view showing the construction of the twenty-first embodiment of a yoke type magnetic head according to the present invention;

FIG. 28 is a sectional view showing the construction of the twenty-second embodiment of a yoke type magnetic head according to the present invention;

FIG. 29 is a sectional view showing the construction of the twenty-third embodiment of a yoke type magnetic head according to the present invention;

FIG. 30 is a sectional view showing the construction of the twenty-fourth embodiment of a yoke type magnetic head according to the present invention;

FIG. 31 is a sectional view showing the construction of an MR element of the twenty-fifth embodiment of a yoke type magnetic head according to the present invention;

FIG. 32 is a sectional view showing the construction of the twenty-sixth embodiment of a yoke type magnetic head according to the present invention;

FIG. 33 is a sectional view showing steps of fabricating the twenty-seventh embodiment of the present invention;

FIG. 34 is a sectional view showing steps of fabricating the twenty-eighth embodiment of the present invention;

FIG. 35 is a schematic diagram for explaining problems of a conventional yoke type magnetic head;

FIG. 36 is a sectional view showing the construction of the twenty-ninth embodiment of the present invention;

FIG. 37 is a perspective view showing steps of fabricating the thirtieth embodiment of the present invention;

FIG. 38 is a perspective view showing steps of fabricating the thirtieth embodiment of the present invention;

FIG. 39 is a sectional view showing steps of fabricating the thirtieth embodiment of the present invention;

FIG. 40 is a sectional view showing steps of fabricating the thirtieth embodiment of the present invention;

FIG. 41 is a sectional view showing steps of fabricating the thirtieth embodiment of the present invention;

FIG. 42 is a sectional view showing steps of fabricating the thirty-first embodiment of the present invention;

FIG. 43 is a view showing steps of fabricating the thirty-second embodiment of the present invention;

FIG. 44 is a sectional view showing a step of fabricating the thirty-third embodiment of the present invention;

FIG. 45 is a sectional view showing a step of fabricating the thirty-third embodiment of the present invention;

FIG. 46 is a sectional view showing a step of fabricating the thirty-third embodiment of the present invention;

FIG. 47 is a sectional view showing a step of fabricating the thirty-third embodiment of the present invention;

FIG. 48 is a sectional view showing a step of fabricating the thirty-third embodiment of the present invention;

FIG. 49 is a sectional view showing a step of fabricating the thirty-third embodiment of the present invention;

FIG. 50 is a sectional view showing a step of fabricating the thirty-third embodiment of the present invention;

FIG. 51 is a sectional view showing a step of fabricating the thirty-third embodiment of the present invention;

FIG. 52 is a sectional view showing a step of fabricating the thirty-third embodiment of the present invention;

FIG. 53 is a sectional view showing a step of fabricating the thirty-third embodiment of the present invention;

FIG. 54 is a sectional view showing a step of fabricating the thirty-third embodiment of the present invention;

FIG. 55 is a sectional view showing a step of fabricating the thirty-third embodiment of the present invention;

FIG. 56 is a sectional view showing a step of fabricating the thirty-third embodiment of the present invention;

FIG. 57 is a sectional view for explaining effects of a yoke type magnetic head fabricated in the thirty-third embodiment of the present invention;

FIG. 58 is an illustration for explaining an example of effects of the yoke type magnetic head in the twenty-ninth embodiment;

FIG. 59 is a sectional view for explaining a modified example of a fabricating step in the thirtieth embodiment;

FIG. 60 is a sectional view for explaining a modified example of a fabricating step in the thirtieth embodiment;

FIG. 61 is a sectional view for explaining a modified example of a fabricating step in the thirtieth embodiment;

FIG. 62 is a perspective view showing the schematic construction of a principal part of a magnetic disk unit according to the present invention;

FIG. 63 is an enlarged perspective view of a magnetic head assembly in front of an actuator arm, which is viewed from the side of a disk; and

FIG. 64 is a sectional view showing the construction of a conventional magnetic head.

### DESCRIPTION OF THE EMBODIMENTS

Referring now to the accompanying drawings, the embodiments of the present invention will be described below.

First Embodiment

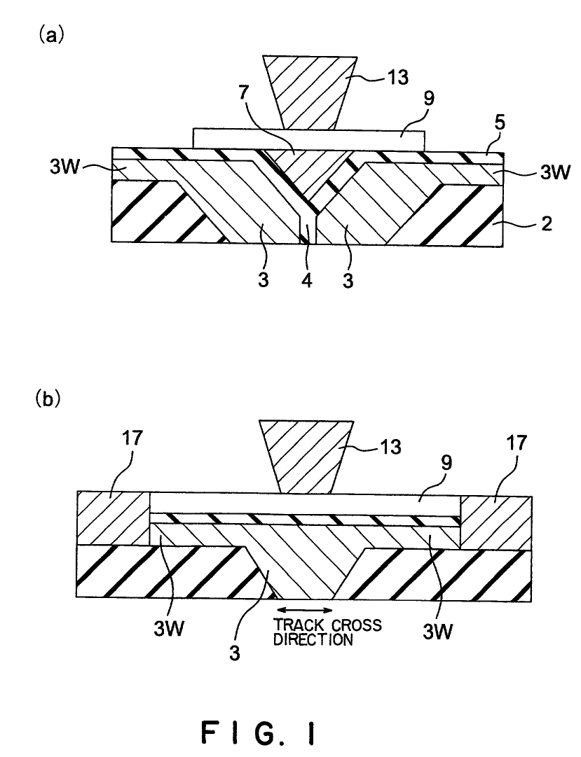

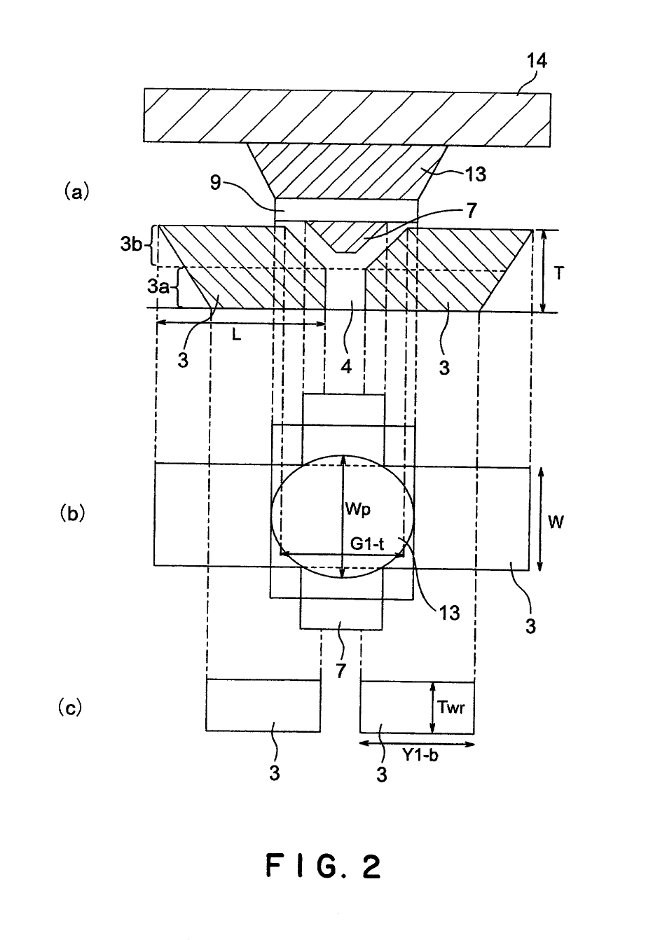

Referring to FIGS. 1 and 2, the first embodiment of a yoke type magnetic head according to the present invention will be described below. The yoke type magnetic head in this embodiment is a horizontal yoke type magnetic head, the cross section of which in track longitudinal directions is shown in FIG. 1(a) and the cross section of which in track cross directions is shown in FIG. 1(b). If the sizes of components of the yoke type magnetic head in this embodiment are expressed, the cross section in track longitudinal directions is shown in FIG. 2(a), the top view is shown in FIG. 2(b), and the medium facing surface is shown in FIG. 2(c). The magnetic head in this embodiment comprises: a pair of magnetic yokes which are arranged so as to face each other via a magnetic gap 4; a bottom electrode 7 which is provided in the magnetic gap 4 via an insulating film 5; a magnetoresistance effect film (which will be also hereinafter referred to as an MR film) of a current perpendicular to plane type, which is provided on the magnetic yoke 3 via the insulating film 5 so as to be electrically connected to the bottom electrode 7; a top electrode 14 (see FIG. 2) which is provided on the MR film 9 and which is electrically connected to the MR film 9 via a pillar portion 13; and a bias magnetic field applying film 17.

The MR film includes at least a pin layer, a free layer and a spacer layer sandwiched between the pin layer and the free layer. The MR film may also include an underlayer, a cap layer and an MR element bias point control layer. In the MR film 9 used in this embodiment, the free layer is preferably provided on the side of the magnetic yoke 3. Thus, reluctance as a magnetic circuit is reduced. In this case, if the underlayer is provided below the above-described free layer on the side of the magnetic yoke 3, the underlayer is as thin as possible. If possible, it is desired that no underlayer is provided.

The MR element shown in the figure comprises a pin layer, a free layer, a spacer layer sandwiched therebetween, an antiferromagnetic layer, a cap layer and an underlayer. The underlayer and the cap layer (protection layer) are herein defined in accordance with the order in the formation of the MR film. During the formation, the lowermost layer is defined as the underlayer, and the uppermost layer is defined as the cap layer.

As the MR film, a spin valve (SV) filmor a TMR film utilizing the tunnel effect is used. In the case of the SV film, a layer of Cu is used as the spacer layer. In the case of the TRM film, a high specific resistance film of a few MΩ/cm, such as a film of Al₂O₃, AlOₓ, or Al/AlOₓ, or an insulating film is used.

The free layer and the pin layer are formed of an NiFe alloy film, a CoFe film, an α-CoFeB film or a Co film which are based on a ferromagnetic material atom, such as Fe, Co or Ni.

In addition to monolayer films such as the CoFe film and Co film, the free layer may be a free layer of a multilayer structure such as CoFe/NiFe or [CoFe/Cu]ₓ.

The pin layer may also be a monolayer film, such as a CoFe film or a Co film, or a synthetic type pin layer having a layer structure, such as CoFe/Ru/CoFe or [CoFe/Cu]ₓ/Ru/[CoFe/Cu]ₓ. As the MR film, a dual-free SV-MR film or a dual-pin SV-MR film is used. An MR film having a specular layer using the specular effect of electrons on the interface may also be used.

In this embodiment, a synthetic pin layer having a film structure of 5 Ta/NiFe/[CoFe/Cu]ₓ /CoFe/3 Cu/[CoFe/Cu]/CoFe/0.7 Ru/[CoFe/Cu]/CoFe/15 PtMn/5 Ta (nm), and an MR film having a multilayer free layer were used. The figure described before the chemical formula is a thickness of the layer expressed by the chemical formula.

Furthermore, the above-described MR film structure can be applied to all of the embodiments of a yoke type magnetic head according to the present invention.

Although the MR film 9 and the magnetic yoke 3 are magnetically connected to each other, they are electrically insulated from each other. The pair of magnetic yokes 3 and the free layer of the MR layer 9 form a magnetic circuit. Each of the pair of magnetic yokes 3 has a wing portion 3w. Furthermore, in order to control the magnetic domain of the pair of magnetic yokes 3 in track cross directions, the bias magnetic field applying film 17 is provided on the side portion of each of the magnetic yokes in track cross directions. In the magnetic yokes 3 of the magnetic head in this embodiment, the magnetic yoke wing portions 3ware magnetic-anisotropy-controlled by a bias system based on the magnetically hard film 17 using the abutted junction system. When the anisotropy control is carried out by means of a hard bias film using the abutted junction system, the thickness of the magnetic yoke wing portions 3wis preferably 50 nm or less, more preferably 30 nm or less.

The magnetic head in this embodiment is a magnetic reproducing head which can be applied to either a vertical recording and/or reproducing system or an in-plane recording and/or reproducing system.

As shown in FIG. 2(a), the magnetic yoke 3 is separated into a tip portion 3aand a rear portion 3b in order from the medium facing surface for convenience. In this embodiment, a wing yoke having a part of the magnetic yoke rear portion 3b extending in-plane directions is formed in order to carry out the anisotropy control of the magnetic yoke 2 as shown in FIG. 1. It is also considered that no wing portion 3wis provided. In FIG. 2, the wing portion 3wis omitted for convenience.

There are some cases where an auxiliary magnetic yoke for controlling the magnetic anisotropy of the magnetic yoke 3 and for reducing a diamagnetic field is provided on the magnetic yoke rear portion 3w.

The magnetic yoke 3 is formed of a magnetically soft ferromagnetic material such as a film of NiFe, α-CoZrNb or FeCo. Since there are some cases where the tip portion of the magnetic yoke 3 is fabricated simultaneously with the tip portion of the magnetic pole of a recording head in a process for fabricating the magnetic head, it is considered that the material of the tip portion of the magnetic yoke 3 is the same as the material of the tip portion of the magnetic pole of the recording head. In this case, a high saturation magnetization material is used. The directions of anisotropy (the directions of the axis of easy magnetization) of the magnetic yoke 3 are controlled by utilizing a bias magnetic field from the outside and a shape anisotropy so as to be in parallel to recording medium track cross directions. In this embodiment, the wing portion 3wis formed of a thin film of a magnetically hard material, and a bias is applied in track cross directions to control the anisotropy of the magnetic yoke. The above-described auxiliary magnetic yoke is effective in the facilitation of the control of anisotropy. The directions of the axis of easy magnetization of the material of the magnetic yoke 3 are track cross directions, and bit length directions are the directions of the axis of hard magnetization. The anisotropic magnetic field (Hk) in the directions of the axis of hard magnetization depends on the magnitude of the diamagnetic field based on the shape of the magnetic yoke 3. The anisotropic magnetic field (Hk) must be at least Hk=10 (Oe), and is preferably 15 (Oe) or more.

The shape of the tip portion 3a of the magnetic yoke 3 is greatly influenced by the diamagnetic field based on the shape, due to the scale down based on the enhancement of the packing density. Therefore, the shape must be determined so that the diamagnetic field is small with respect to magnetic flux penetrating directions, i.e., magnetic path directions. In the case of the magnetic head in this embodiment, the diamagnetic field in directions perpendicular to the medium facing surface must be small. Therefore, as shown in FIG. 2, assuming that the maximum thickness of the magnetic yoke 3 from the medium facing surface of the magnetic head in this embodiment is T, the maximum length of the magnetic yoke tip portion 3a in track cross directions is W, and the maximum length of the magnetic yoke tip portion 3a in bit length directions is L (it is considered so that the above described wing portions are omitted when the wing portions are provided), then, the following expressions are preferably satisfied:

0<L/W≦1, 0.1≦T/W≦10,

following expressions are more preferably satisfied.

0<L/W≦0.5, 0.5≦T/W≦5.

This condition is effective in the control of anisotropy of the magnetic yoke tip portion 3a.

The thickness of the magnetic yoke tip portion 3a is preferably 100 nm or less, more preferably 50 nm or less. If the thickness is 100 nm or less, the medium signal magnetic flux can sufficiently flow into the MR element portion 9, and if the thickness is 50 nm or less, the anisotropy control of the magnetic yoke 3 can be easily carried out. The thickness of the magnetic yoke rear portion 3b is determined by the thickness values of T, W, L and the magnetic yoke tip portion 3a as described above.

The crystal grains of the magnetic material used for the magnetic yoke 3 must be scaled down by the scale down of the magnetic yoke according to the enhancement of the packing density. In view of the magnetically soft characteristics of the material, the maximum crystal grain size of the material used for the magnetic yoke 3 is preferably at least ½ or less as large as a reproducing head track width. The mean crystal grain side is preferably 1/10 as large as the track width. Furthermore, the maximum crystal grain size and the mean crystal grain size can be observed and identified by means of an electron microscope or the like.

The pair of magnetic yokes 3 is arranged on the same plane so as to sandwich the magnetic gap 4 therebetween. The formed surfaces of the magnetic yokes 3 are substantially in parallel to the medium facing surface. As shown in FIGS. 1 and 2, the magnetic gap 4 has such a shape that it is gradually widened from the side of the medium facing surface. Preferably, the magnetic gap 4 has no corner, and its counter is drawn by a curve which is as smooth as possible. In the magnetic gap 4, the widest portion is preferably 10 times or less, more preferably 5 times or less, as large as the narrowest portion.

As shown in FIGS. 1 and 2, the top electrode 14 and the pillar portion 13 are formed right above the magnetic gap 4. The pillar portion 13 herein means a protruding portion of the top (or bottom) electrode 14 which protrudes toward the MR film 9. On the other hand, as shown in FIGS. 1 and 2, the bottom electrode 7 is formed so as to be embedded in at least a part of the magnetic gap 4. It is not required to embed the whole bottom electrode 7 in the magnetic gap 4, and a part of the bottom electrode 7 may exist between the MR film 9 and the magnetic yoke 3. However, in this case, the thickness of the electrode is not preferably greater than the magnetic gap length, more preferably half or less the magnetic gap length. As the material of the top and bottom electrodes, a low resistance metal such as Cu, Au, Ag, W or Ta is used. It is not required to fill the bottom electrode 7 in all of the magnetic yoke 3, and a portion of the magnetic gap 4 on the side of the medium facing surface is preferably filled with an electrical insulating material, e.g., an oxide such as AlOₓ or SiOₓ, or a nitride such as AlNₓ or SiNₓ.

In the junction between the pillar portion 13 and the MR film 9, the junction width (Wp) of the pillar portion 13 in track cross directions is preferably greater than the magnetic yoke width (W). Thus, it is possible to suppress the influence of a magnetic field on the free layer due to the current perpendicular to plane, so that it is possible to connect the electrode to the free layer portion having a great magnetization rotation. Therefore, a high output can be expected.

The top and bottom electrodes 7 and 14 are connected to wide, thick and low resistance second top and bottom electrodes (not shown), respectively.

As described above, according to the magnetic head in this embodiment, the flow of the magnetic flux into the magnetoresistance effect film 9 is smoother than that in conventional magnetic heads by forming the bottom electrode of the magnetoresistance effect element in the magnetic gap, so that it is possible to prevent the magnetic flux efficiency from lowering. It is also possible to shorten the magnetic path since the magnetic head in this embodiment is the horizontal yoke type magnetic head.

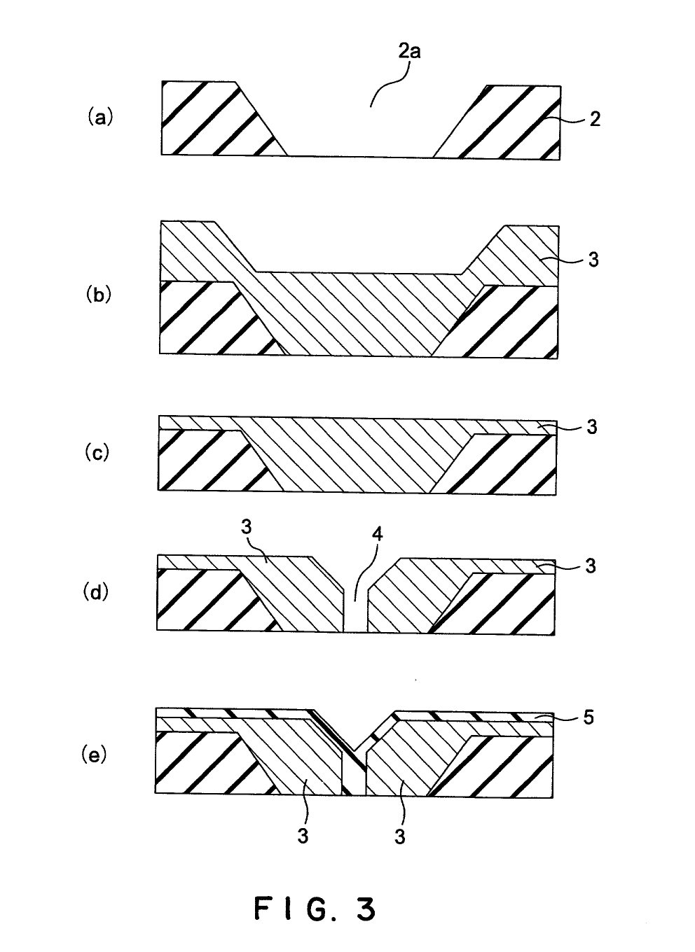

Referring to FIG. 3, a method for fabricating a yoke type magnetic head in this embodiment will be described below.

First, as shown in FIG. 3(a), an insulating film 2 of, e.g., SiOₓ or AlOₓ, is deposited on a substrate, and a resist pattern of a resist is formed on the insulating film 2 by the photolithography technique. This resist pattern is used as a mask for patterning the insulating film 2 by a dry etching method, such as ion milling or active ion etching, to form a groove 2a in the insulating film 2.

Then, as shown in FIG. 3(b), the groove 2a is filled with a magnetic yoke material by the plating or sputtering method, to form a magnetic yoke layer 3. Subsequently, as shown in FIG. 3(c), the magnetic yoke layer 3 is flattened by the chemical mechanical polishing (CMP) or the like.

Then, as shown in FIG. 3(d), a reproducing magnetic gap 4 is formed in the magnetic yoke layer 3 by a PEP (electron beam exposure, excimer laser exposure or the like) and a dry etching (ICP plasma RIE, ECR plasma RIE or the like). Thereafter, an insulating film 5 of AlOₓ or DLC (diamond-like-carbon) is formed in a part of the reproducing magnetic gap 4 and on the magnetic yoke 3.

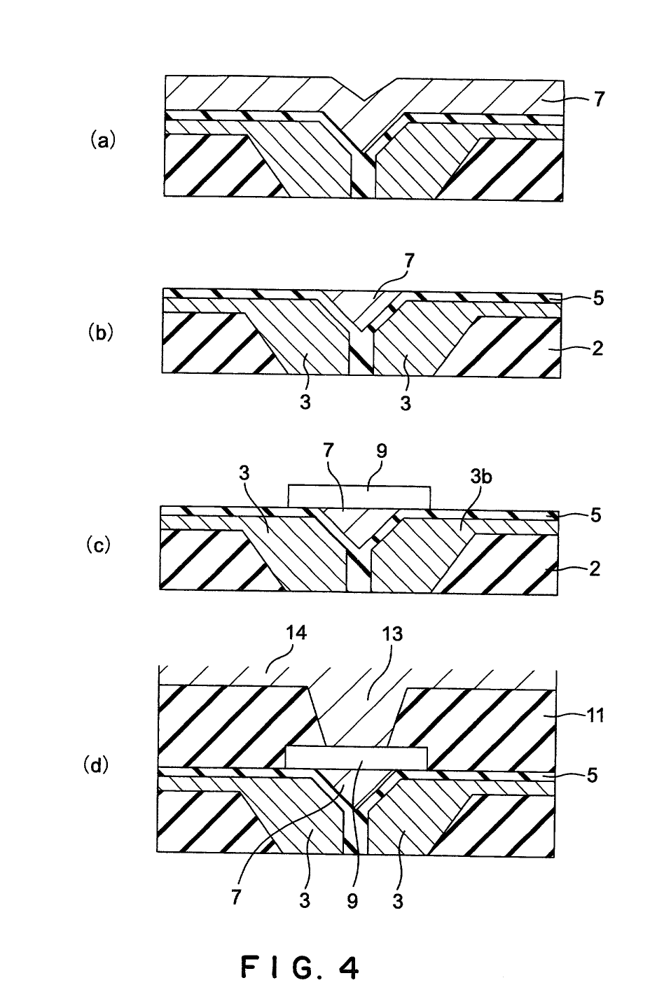

Then, as shown in FIG. 4(a), a film 7 of a bottom electrode material is formed on the insulating film 5. Then, as shown in FIG. 4(b), the surface of the film 7 of the bottom electrode material is flattened by the CMP or the like. Thereafter, as shown in FIG. 4(c), after an MR material film is deposited, an MR film 9 is formed by the PEP and the dry etching. Subsequently, as shown in FIG. 4(d), an insulating film 11 is formed so as to cover the MR film 9, and a contact hole to the MR film 9 is formed in the insulating film 11 by the PEP and the dry etching. Thereafter, a pillar portion 13 and a top electrode 14 are formed by filling the top electrode material in the contact hole by the plating or sputtering method (see FIG. 4(d)).

By the above-described fabricating steps, a horizontal yoke type magnetic head in the first embodiment is formed.

While the magnetic gap has been first formed on the side of the substrate at the above-described yoke type magnetic head fabricating steps, the top electrode 14, the MR film 9, the bottom electrode 7, the magnetic yoke 3 and the magnetic gap 4 may be formed in that order, i.e., the magnetic gap 4 may be finally formed.

Second Embodiment

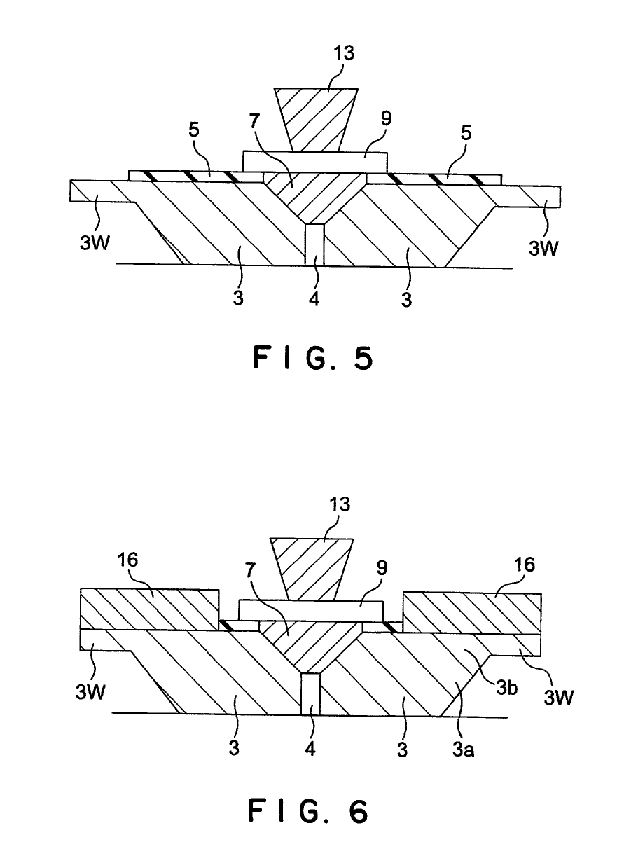

The construction of the second embodiment of a yoke type magnetic head according to the present invention is shown in FIG. 5. In the magnetic head in this embodiment, the insulating film provided between the bottom electrode 7 and the magnetic yoke 3 in the magnetic head in the first embodiment is removed, and the MR film 9 is electrically insulated from the magnetic yoke 3 although the bottom electrode 7 is electrically connected to the magnetic yoke 3.

Thus, in this embodiment, the bottom electrode 7 is electrically connected to the magnetic yoke 3, so that a sense current can flow through the MR film 9 to lower the resistance of the electrode. In addition, the sense current substantially isotropically flows about the MR film 9, so that it is possible to reduce the influence of the magnetic field on the magnetic yoke 3 and the free layer of the MR film 9 due to the current.

According to the magnetic head in this embodiment, the flow of the magnetic flux into the magnetoresistance effect film 9 is smoother than that in conventional magnetic heads by forming the bottom electrode of the magnetoresistance effect element in the magnetic gap, so that it is possible to prevent the magnetic flux efficiency from lowering. Since the magnetic head in this embodiment is also the horizontal yoke type magnetic head, it is possible to shorten the magnetic path.

Third Embodiment

The construction of the third embodiment of a yoke type magnetic head according to the present invention is shown in FIG. 6. In the magnetic head in this embodiment, the auxiliary magnetic yoke 16 is provided on the magnetic yoke rear portion 3b in the magnetic head in the second embodiment for controlling the anisotropy of the magnetic yoke.

Thus, the control of anisotropy in track cross directions can be easily carried out, and the diamagnetic field of the magnetic yoke 3 can be reduced, so that it is possible to improve the magnetic attraction efficiency of the magnetic yoke.

According to the magnetic head in this embodiment, the flow of the magnetic flux into the magnetoresistance effect element is smoother than that in conventional magnetic heads by forming the bottom electrode of the magnetoresistance effect element in the magnetic gap, so that it is possible to prevent the magnetic flux efficiency from lowering. Since the magnetic head in this embodiment is also the horizontal yoke type magnetic head, it is possible to shorten the magnetic path.

Fourth Embodiment

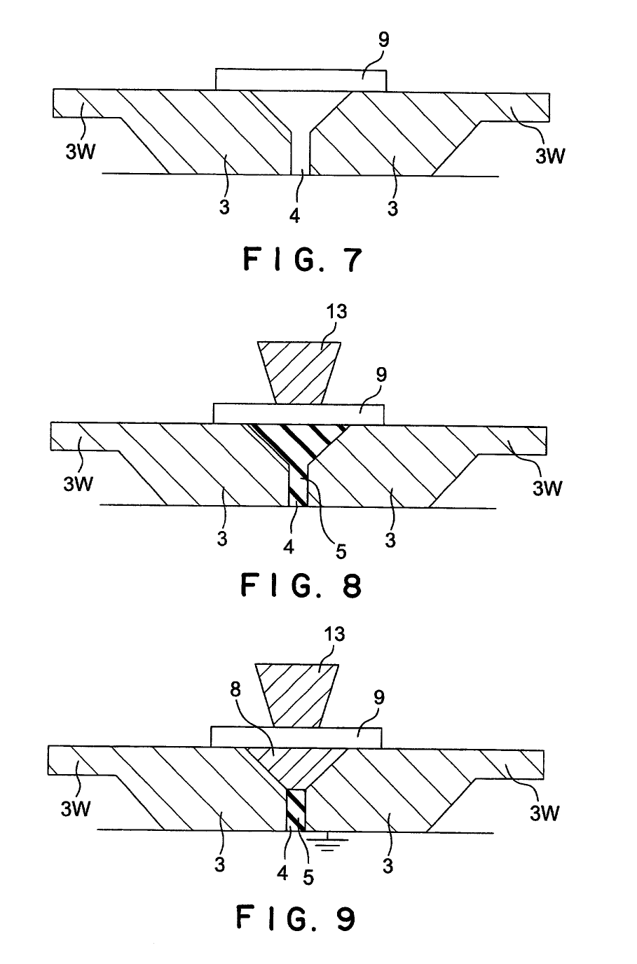

The construction of the fourth embodiment of a yoke type magnetic head according to the present invention is shown in FIG. 7. The magnetic head in this embodiment is a yoke type magnetic head using a current perpendicular to plane type MR film, and has a construction wherein a current perpendicular to plane type MR film 9 is formed on the opposite surfaces of a pair of magnetic yokes 3, which are arranged so as to face each other via a magnetic gap 4, to the medium facing surfaces. In this embodiment, the magnetic yokes 3 also serve as a bottom electrode. Thus, it is possible to decrease a spacing (distance) between the MR film 9 and the magnetic yokes 3, so that it is possible to decrease reluctance of the magnetic circuit. Since the magnetic head in this embodiment is also the horizontal yoke type magnetic head, it is possible to shorten the magnetic path.

Fifth Embodiment

The construction of the fifth embodiment of a yoke type magnetic head according to the present invention is shown in FIG. 8. The magnetic head in this embodiment is a yoke type magnetic head using a current perpendicular to plane type MR film having a pillar portion 13, and has a construction wherein a current perpendicular to plane type MR film 9 is formed on the opposite surfaces of a pair of magnetic yokes 3, which are arranged so as to face each other via a magnetic gap 4, to the medium facing surfaces. Furthermore, the magnetic gap 4 is filled with an insulating film 5. In this embodiment, the magnetic yokes 3 also serve as a bottom electrode. Thus, it is possible to decrease a spacing (distance) between the MR film 9 and the magnetic yokes 3, so that it is possible to decrease reluctance of the magnetic circuit. Since the magnetic head in this embodiment is also the horizontal yoke type magnetic head, it is possible to shorten the magnetic path.

Sixth Embodiment

The construction of the sixth embodiment of a yoke type magnetic head according to the present invention is shown in FIG. 9. In the magnetic head in this embodiment, a part of the insulating film 5 in the magnetic head in the fifth embodiment shown in FIG. 8 is replaced with a non-magnetic electric conductor 8. By this electric conductor 8, the MR film 9 is electrically connected to a pair of magnetic yokes 3. The pair of magnetic yokes 3 have the same potential and are grounded.

Also in this embodiment, the magnetic yokes 3 also serve as a bottom electrode. Therefore, it is possible to decrease a spacing (distance) between the MR film 9 and the magnetic yokes 3, so that it is possible to decrease reluctance of the magnetic circuit. Since the magnetic head in this embodiment is also the horizontal yoke type magnetic head, it is possible to shorten the magnetic path. Moreover, since the MR film 9 is electrically connected to the pair of magnetic yokes 3 by means of the electric conductor 8, it is possible to reduce the resistance of the bottom electrode.

Seventh Embodiment

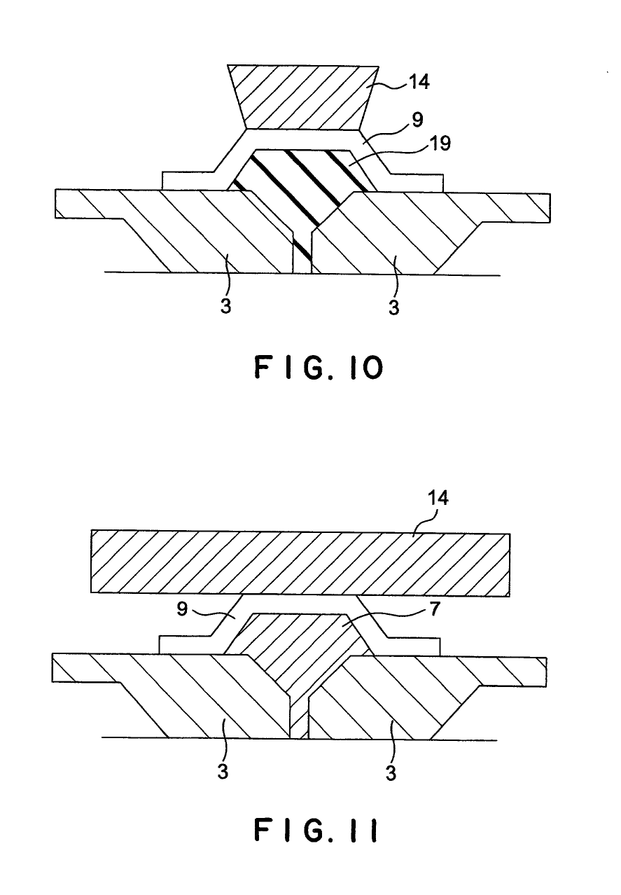

The construction of the seventh embodiment of a yoke type magnetic head according to the present invention is shown in FIG. 10. The magnetic head in this embodiment comprises: a pair of magnetic yokes 3 which are arranged so as to face each other via a magnetic gap 4; a protruding insulating film 19 which is formed so as to be filled in the magnetic gap 4; an MR film 9 which is formed on the protruding insulating film 19; and a top electrode 14 which is formed on the MR film 9.

In the magnetic head in this embodiment, the junction between the top electrode 14 and the MR film 9 can be self-aligned by utilizing the protruding portion. Thus, the position shift of the magnetic gap 4 from the junction can be decreases although it is difficult to accomplish this in the prior art, and a sense current can be concentrically supplied to the high sensitive portion of the MR element, so that it is possible to obtain a high output.

Since the magnetic head in this seventh embodiment is also the horizontal yoke type magnetic head, it is possible to shorten the magnetic path.

Eighth Embodiment

The construction of the eighth embodiment of a yoke type magnetic head according to the present invention is shown in FIG. 11. In the magnetic head in this embodiment, the protruding insulating film 19 in the magnetic head in the seventh embodiment shown in FIG. 10 is replaced with a bottom electrode 7, and a top electrode 14 is connected directly to the MR film 9.

Also in this embodiment similar to the seventh embodiment, the position shift of the magnetic gap 4 from the junction can be decreases although it is difficult to accomplish this in the prior art, and a sense current can be concentrically supplied to the high sensitive portion of the MR film 9. Since the magnetic head in this eighth embodiment is also the horizontal yoke type magnetic head, it is possible to shorten the magnetic path.

Ninth Embodiment

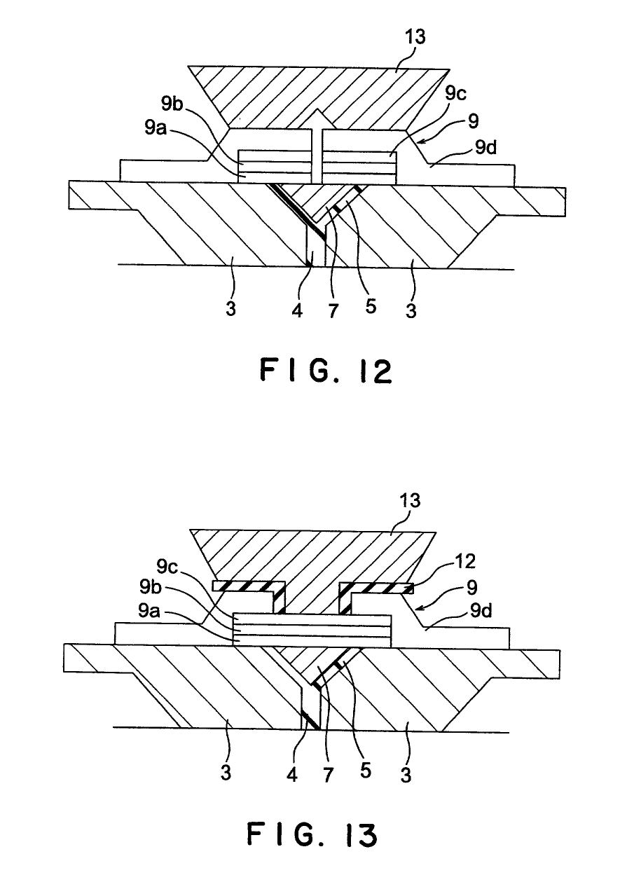

The construction of the ninth embodiment of a yoke type magnetic head according to the present invention is shown in FIG. 12. The magnetic head in this embodiment comprises: a pair of magnetic yokes 3 which are arranged so as to face each other via a magnetic gap 4; a bottom electrode 7; a current perpendicular to plane type MR film 9 which is formed on the magnetic yokes 3; and a pillar portion 13. The bottom electrode 7 is provided in the magnetic gap 4, and is electrically insulated from the magnetic yokes 3 by means of an insulating film 5. The MR film 9 comprises a pin layer 9a a spacer layer 9b, and free layers 9c and 9d. The pin layer 9a the spacer layer 9b and the free layer 9c are stacked. The pin layer 9a is connected directly to the bottom electrode 7, and is connected directly to the opposite surfaces of the magnetic yokes 3 to the medium facing surface. The free layer 9 is formed on the magnetic yokes 3 so as to cover the pin layer 9a the spacer 9b and the free layer 9c which are stacked. The pillar portion 13 is formed on a region of the free layer 9d right above the magnetic gap 4, and is connected to a top electrode (not shown).

In the magnetic head in this embodiment, the flow of the magnetic flux into the magnetoresistance effect element 9 is smoother than that in conventional magnetic heads by forming the bottom electrode 7 in the magnetic gap 4, so that it is possible to prevent the magnetic flux efficiency from lowering. Since the magnetic head in this embodiment is a horizontal yoke type magnetic head, it is possible to shorten the magnetic path. The top electrode (not shown) can be formed so as to be self-aligned by utilizing the protruding portion of the MR film 9. Thus, the top electrode can be formed right above the magnetic gap 4 without position shift, and a sense current can be applied to the highest sensitive portion of the MR film 9, so that it is possible to obtain a high output.

Furthermore, the pin layer means a ferromagnetic layer which is magnetization-fixed by an antiferromagnetic layer, i.e., which is switched-connected to an antiferromagnetic layer, and is arranged between the above-described spacer layer and the antiferromagnetic layer. The above-described ferromagnetic layer is a ferromagnetic layer containing any one of Fe, Co and Ni of CoFe and NiFe alloys. The above-described ferromagnetic layer is a monolayer film or a multilayer film. The multilayer films include a synthetic magnetization fixing layer utilizing an antiferromagnetic correlation connection, such as CoFe/Ru/CoFe, and a magnetization fixing layer utilizing a ferromagnetic connection, such as CoFe/intermediate layer/CoFe, in addition to a stacked layer, such as CoFe/NiFe. The intermediate layer is sometimes a layer called an electron reflecting layer wherein electrons are mirror-reflected on the interface between layers. For example, the intermediate layers include oxide or nitride layers, such as an α-Fe₂O₃layer, a CoO layer and an NiO layer, noble metal alloy layers, such as an Au layer and an Ru layer, and combinations thereof.

The free layer has a monolayer or multilayer structure comprising a layer containing a ferromagnetic layer. The free layer comprises a layer containing any one of Fe, Co and Ni. For example, the above described magnetization free layers having the multilayer structure include a CoFe/NiFe layer, a Co/NiFe layer, and stacked films of ferromagnetic layer/antiferromagnetic layer, such as [CoFe/Cu]ₓ, [Co/Cu]ₓ and [NiFe/Cu]ₓ(X is the number of stacked layers).

Tenth Embodiment

The construction of the tenth embodiment of a yoke type magnetic head according to the present invention is shown in FIG. 13. In the magnetic head in this embodiment, the pillar portion 13 in the magnetic head in the ninth embodiment shown in FIG. 12 is connected to the free layer 9c via a contact hole which is formed in the free layer 9d. Furthermore, the pillar portion 13 is electrically insulated from the free layer 9d by means of an insulating film 12.

Also in the magnetic head in this embodiment, the flow of the magnetic flux into the magnetoresistance effect film 9 is smoother than that in conventional magnetic heads by forming the bottom electrode 7 in the magnetic gap 4, so that it is possible to prevent the magnetic flux efficiency from lowering. Since the magnetic head in this embodiment is also a horizontal yoke type magnetic head, it is possible to shorten the magnetic path. In addition, in the magnetic head in this embodiment, the thickness of the free layer of the MR film 9 connected to the top electrode (pillar portion 13) can be smaller than that in the magnetic head in the ninth embodiment shown in FIG. 12. Therefore, the density of the signal magnetic flux penetrating the free layer is improved, so that the magnetization rotation of the free layer increases. Thus, it is possible to increase output.

Eleventh Embodiment

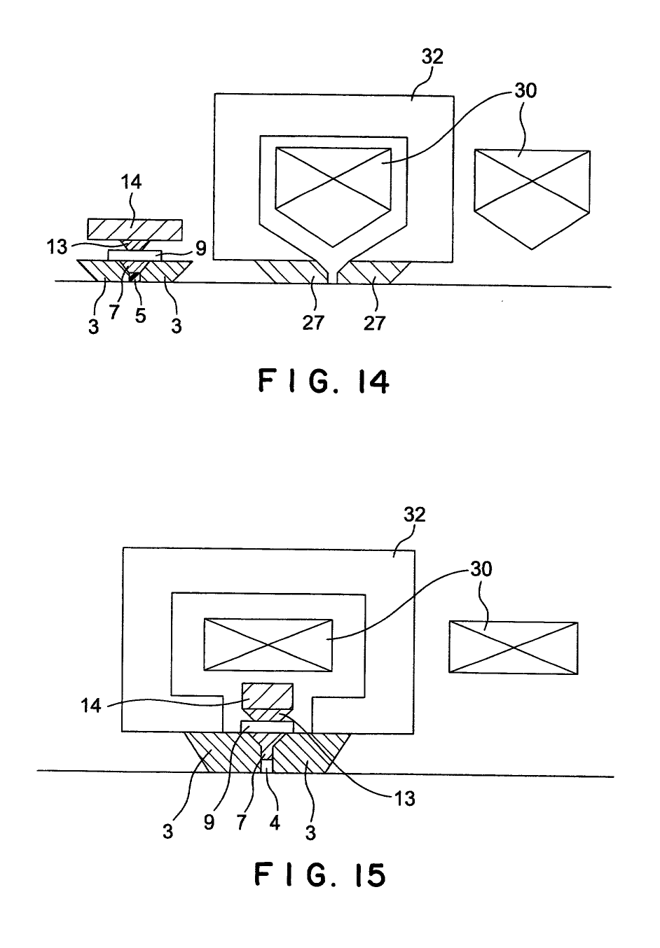

The construction of the eleventh embodiment of a yoke type magnetic head according to the present invention is shown in FIG. 14. The magnetic head in this embodiment is a recording/reproducing portion separated type magnetic head which uses the magnetic head in the sixth embodiment shown in FIG. 9 as a magnetic reproducing head, and the sectional view thereof in track longitudinal directions is shown in FIG. 14. In FIG. 14, reference number 27 denotes a magnetic yoke of a magnetic recording head, reference number 30 denotes a recording coil, and reference number 32 denotes an auxiliary magnetic pole. Furthermore, as the magnetic reproducing head, any one of the magnetic heads in the first through fifth and seventh through tenth embodiments may be used in place of the magnetic head in the sixth embodiment shown in FIG. 9.

Twelfth Embodiment

The construction of the twelfth embodiment of a yoke type magnetic head according to the present invention is shown in FIG. 15. The magnetic head in this embodiment is a recording/reproducing portion integrated type magnetic head which uses the magnetic head in the sixth embodiment shown in FIG. 9 as a magnetic reproducing head, and the sectional view thereof in track longitudinal directions is shown in FIG. 15. In FIG. 15, reference number 30 denotes a recording coil, and reference number 32 denotes an auxiliary magnetic pole. Furthermore, as the magnetic reproducing head, any one of the magnetic heads in the first through fifth and seventh through tenth embodiments may be used in place of the magnetic head in the sixth embodiment shown in FIG. 9.

Thirteenth Embodiment

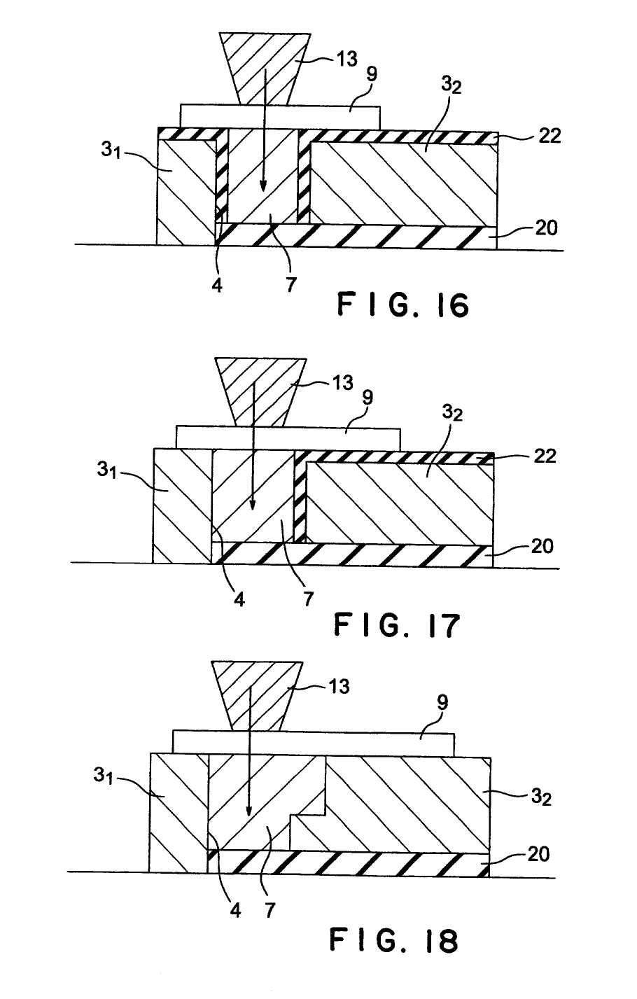

The construction of the thirteenth embodiment of a yoke type magnetic head according to the present invention is shown in FIG. 16. The magnetic head in this embodiment is a single magnetic pole type reproducing head which is mainly used for the vertical recording/reproducing system, and the sectional view thereof in track longitudinal directions is shown in FIG. 16. The magnetic head in this embodiment comprises: a pair of magnetic yokes 3₁ and 3₂ which are arranged so as to face each other via a magnetic gap 4; a bottom electrode 7 which is provided in the magnetic gap 4 via an insulating film 5; a current perpendicular to plane type magnetoresistance effect film (which will be also hereinafter referred to as an MR film) 9 which provided on the magnetic yokes 3₁ and 3₂ via the insulating film 5 so as to be electrically connected to the bottom electrode 7; and a top electrode 14 (not shown) which is provided on the MR film 9 and which is electrically connected to the MR film 9 via a pillar portion 13. Furthermore, the magnetic yoke 3₂ and the bottom electrode 7 are arranged so as to face a medium via an insulating film 20. The bottom electrode 7 and the MR film 9 may be electrically connected to the magnetic yoke 3₁ as shown in FIG. 17, or may be electrically connected to the magnetic yokes 3₁ and 3₂.

According to the magnetic head in this embodiment, in comparison with conventional magnetic head, it is possible to prevent the lowering of the magnetic flux by forming the bottom electrode 7 in the magnetic gap 4. In addition, it is possible to lower the resistance of the electrode by electrically connecting the bottom electrode 7 to the magnetic yokes 3.

Fourteenth Embodiment

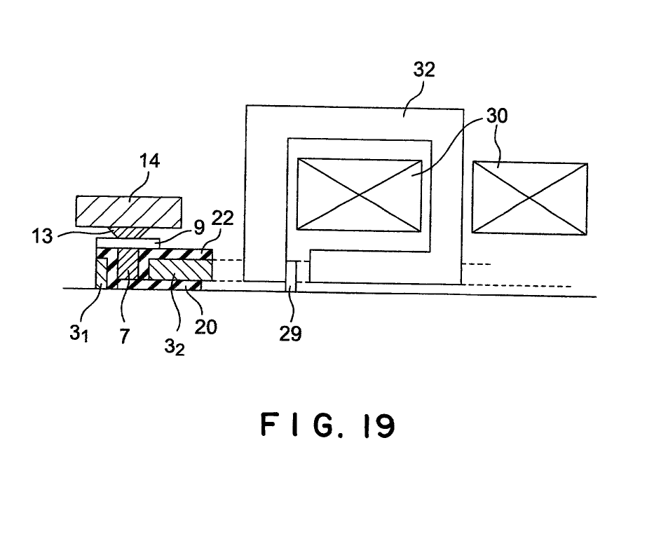

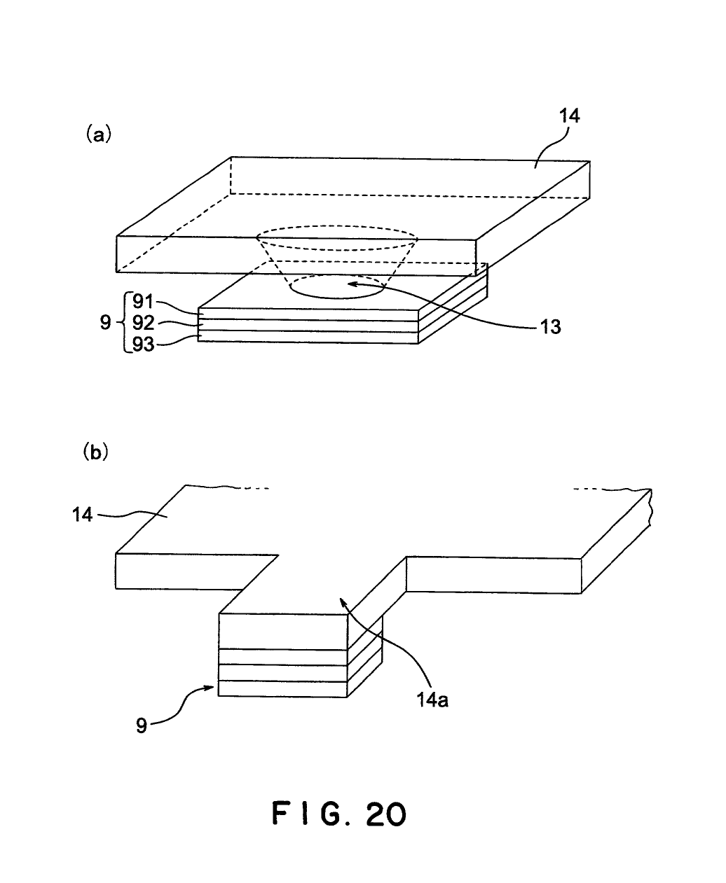

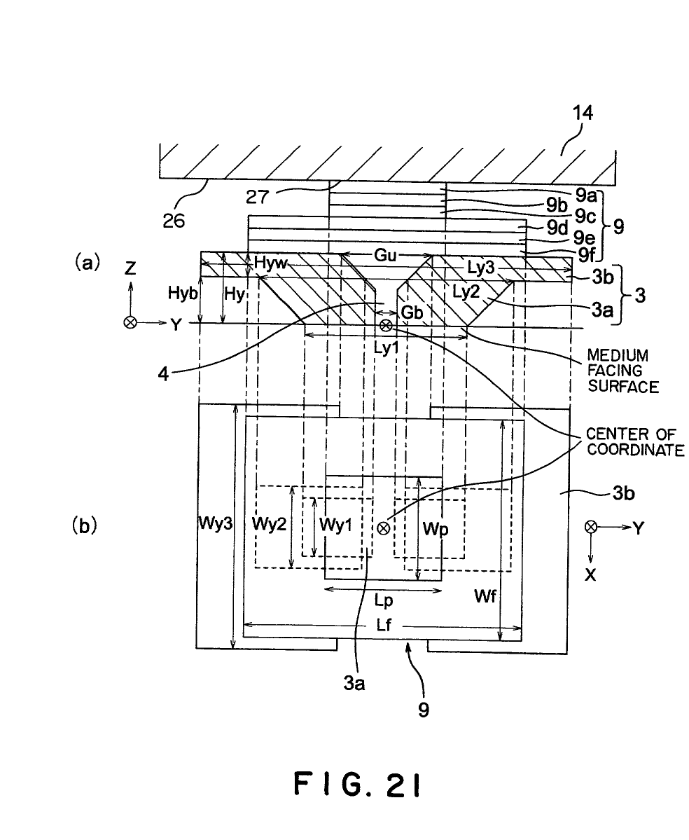

The construction of the fourteenth embodiment of a yoke type magnetic head according to the present invention is shown in FIG. 19. The magnetic head in this embodiment is a recording/reproducing portion separated type magnetic head wherein the magnetic reproducing head using the magnetic head in the thirteenth embodiment shown in FIG. 16 is combined with a single magnetic pole type recording head, and the sectional view thereof in track longitudinal directions is shown in FIG. 19. In FIG. 19, reference number 30 denotes a recording coil, and reference number 32 denotes an auxiliary magnetic pole. Furthermore, as the magnetic reproducing head, any one of magnetic heads shown in FIGS. 17 and 18 may be used in place of the magnetic head in the thirteenth embodiment shown in FIG. 16. Furthermore, as the magnetic recording head, a ring core type recording head shown in FIG. 14 may be used.

Before describing the fifteenth through twenty-eighth embodiments of a yoke type magnetic head according to the present invention, problems of conventional yoke type magnetic heads will be described below.

In a typical current perpendicular to plane type MR film, a current is applied to an MR film 8, which is comprises a pin layer 91, a spacer layer 82 and a free layer 93, from a top electrode 14 via a pillar portion 13 as shown in FIG. 20(a). In this case, there is a problem in that the magnetic field due to the current from the pillar portion 13 has a bad influence on the magnetic anisotropy control of magnetic yokes (not shown) and the free layer 93 of the MR film 9 to deteriorate the proportion of noises to an output signal (S/N ratio).

In addition, if a top electrode 14 is provided with a protruding portion 14a to decrease the area of the junction to an MR film as shown in FIG. 20(b) in order to reduce a portion influenced by the magnetic field due to the current from the pillar portion 13, there is a problem in that it is not possible to overlap with magnetic yokes (not shown), so that reluctance increases and the magnetic flux efficiency decreases.

In the fifteenth through twenty-eighth embodiment which will be described below, it is possible to prevent the lowering of the magnetic flux efficiency, and it is possible to improve the S/N ratio.

Fifteenth Embodiment

The construction of the fifteenth embodiment of a yoke type magnetic head according to the present invention is shown in FIG. 21. The magnetic head in this embodiment is a horizontal yoke type magnetic head, and the sectional view thereof in track cross directions and the top view thereof are shown in FIGS. 21(a) and 21(b), respectively. Furthermore, in FIGS. 21(a) and 21(b), symbols for showing the dimensions of the respective portions are shown. The yoke type magnetic head in this embodiment comprises: a pair of magnetic yokes 3 which are arranged so as to face each other via a magnetic gap 4; a magnetoresistance effect film 9 (which will be also hereinafter referred to as an MR film); a bottom electrode (not shown); and a top electrode 14.

The x-coordinate, y-coordinate and z-coordinate shown in FIGS. 21(a) and 21(b) will be described below. In FIGS. 21(a) and 21(b), the center of coordinates is shown. The center of coordinates is the center of the medium facing surface of the magnetic gap. The x-axis is set so as to extend in track cross directions (which will be hereinafter referred to as cross directions), the y-axis is set so as to extend in bit length directions (which will be hereinafter referred to as length directions), and the z-axis is set so as to extend in directions perpendicular to the medium facing surface (wherein coordinates in a direction leaving from the medium facing surface are positive coordinates and which will be hereinafter referred to as thickness directions). The yoke type magnetic head in this embodiment shown in FIGS. 21(a) and 21(b) is substantially symmetrical with respect to the xz plane and the yz plane.

As shown in FIG. 21, each of the magnetic yokes 3 of the yoke type magnetic head in this embodiment comprises a wing portion 3b and a tip portion (which will be also be referred to as a protruding portion) 3a which has a protruding shape on the side of the medium facing surface. On the medium facing surface, the length of the magnetic yoke 3 in the x-axis directions (which will be hereinafter referred to as width) is defined by Wy1, the end portion thereof is defined by x=±(Wy1)/2, the length of the magnetic yoke 3 in the y-axis directions (which will be hereinafter referred to as length) is defined by Ly1, and the end portion thereof is defined by y=±(Ly1)/2. With respect to the protruding portion 9a the thickness thereof is defined by Hyb, the width of the magnetic yoke at z=Hyb is defined by Wy2, and the end portion in cross directions and the end portion in length directions are defined by x=±(Wy2)/2and y=±(Ly2)/2, respectively.

With respect to the wing portion 3b the thickness thereof is defined by Hyw, the width of the wing portion 3b at z=Hyb +(Hyw)/2is defined by Wy3, and the end portions in cross and length directions are defined by x=±(Wy3)/3 and y=±(Ly3) /2, respectively. Therefore, the sectional area of the tip portion 3a of the magnetic yoke 3 on the medium facing surface is set so as to be smaller than an optional sectional area of the magnetic yoke substantially parallel to the medium facing surface.

As the material of the magnetic yokes 3, a magnetically soft alloy, such as Ni₈₀Fe₂₀(at %) alloy (permalloy) or α-CoZrNb, is used. This material is used as a monolayer film or a stacked film.

In order to reduce BHN (Barkhausen noise), it is important to control the magnetic anisotropy of the magnetic yokes 3. The magnetic anisotropy of the magnetic yokes 3 is controlled by applying a magnetic bias to the magnetic yoke wing portion 3b. As a main system, a bias system using a hard film abut junction system is used. In this case, a CoPt alloy film or a CoCr alloy film is used as a hard film. Assuming that the saturation magnetization and thickness of the wing portion 3b of the magnetic yoke 3 are M_{S-yoke-w} and t_{yoke-w}, respectively, and the residual magnetization and thickness of a hard bias film are Mᵣ and δ, respectively, then, it is desired that the following expression is satisfied.

$$\frac{{M}_{r} \cdot δ}{{M}_{s - yoke - w} \cdot {t}_{yoke - w}} \geq 1.0$$

On the other hand, if the hard abutted junction system is used for controlling the anisotropy control, the thickness of the wing portion 3b of the magnetic yoke 3 is preferably 50 nm or less. Because the coercive force of a Co containing hard film generally decreases due to the c-axis orientation of its crystal structure as the thickness thereof increases, so that the magnetization of a magnetic yoke edge portion can not be fixed.

In addition, the height (Hyb) of the protruding portion of the magnetic yoke 3 is set so that Hyb≦0.2 μm. The sum of the height (Hyb) of the protruding portion 3a and the thickness (Hyw) of the wing portion 9b is the height (Hy=Hyb+Hyw) of the magnetic yoke. The width (Wy1) of the magnetic yoke 3 on the medium facing surface is preferably greater than the length ((Ly1−Gb)/2) thereof, and the height (Hy) of the magnetic yoke 3 is not preferably less than the length ((Ly1−Gb)/2) of the magnetic yoke 3 on the medium facing surface. In this embodiment, the magnetic yoke was produced so that Wy1=0.1 μm, Hy=0.1 μm, (Ly1−Gb)/2=0.05˜0.1 μm, Gb=0.025 μm, Hyb≦0.05 μm and Hyw=0.03 μm.

As shown in FIG. 21, the MR film 9 is formed on the magnetic gap 4 between the top electrode 4 and the magnetic yoke 3. The MR film 9 comprises a cap layer 9a a diamagnetic layer 9b, a pin layer 9c, a spacer layer 9d, a free layer 9e and an underlayer 9f. The underlayer 9f and the cap layer (protection layer) 9a are herein defined in accordance with the order in the formation of the MR film. During the formation, the lowermost layer is defined as the underlayer 9f, and the uppermost layer is defined as the cap layer 9a. Furthermore, the formed surface of the MR film 9 is designed to be substantially parallel to the medium facing surface.

The free layer 9e and the pin layer 9c are formed of an NiFe alloy film, a CoFe film, an α-CoFeB film or a Co film which are based on a ferromagnetic material atom, such as Fe, Co or Ni. The pin layer 9c is formed of a monolayer film, such as a CoFe film or a Co film, or a synthetic type pin layer having a layer structure, such as CoFe/Ru/CoFe or [CoFe/Cu]ₓ /Ru/[CoFe/Cu]ₓ. In addition to monolayer films such as the CoFe film and Co film, the free layer 9e may be a free layer of a multilayer structure, such as CoFe/NiFe or [CoFe/Cu]ₓ. In order to reduce a product of the saturation magnetization and thickness of the free layer, a synthetic type free layer may be used as described with respect to the pin layer 9c.

The thickness of the free layer 9c is determined by reluctance which is formed by the magnetic yoke 3 and the free layer 9e. The thickness of the free layer 9e is preferably thinner unless the magnetic permeability decreases, and is preferably 10 nm or less in conversion to the free layer of permalloy (saturation magnetization: 800 emu/cc) in view of the magnitude of the signal magnetic flux introduced from the magnetic yoke 3 to the free layer 9e.

The cap layer 9a and the underlayer 9f are mainly made of Ta. There are some cases where the underlayer 9f includes an orientation control layer of Cu or Au in order to control the crystal orientation of layers formed thereon. The thickness of the cap layer 9a and the underlayer 9f is 10 nm or less.

The antiferromagnetic layer 9b is made of a regular PtMn alloy, a PdMn alloy or an IrMn alloy. The thickness thereof is in the range of from 5 nm to 20 nm.

As the MR film 9, a spin valve (SV) film or a TMR film utilizing the tunnel effect is used. In the case of the SV film, a layer of Cu is used as the spacer layer. In the case of the TRM film, a high specific resistance film of a few MΩ/cm, such as a film of Al₂O₃, AlOₓ or Al/AlOₓ, or an insulating film is used. As the MR film 9, a dual-free SV-MR film or a dual-pin SV-MR film may be used. An MR film having a specular layer using the specular effect of electrons on the interface may also be used.

In the conventional current perpendicular to plane type MR film 9 shown in FIG. 20(a), a current is applied to the MR film 9 from the portion protruding from the top electrode 14, i.e., the pillar portion 13. At this time, the sense region of the MR film 9 is defined by the area of the junction surface between the pillar portion 13 and the MR film 9. That is, the sense portion is defined by the area of the bottom face of the pillar portion 13.

In addition, in the conventional magnetic head having the top protruding portion 14a shown in FIG. 20(b), the size of the MR film 9 is defined by the protruding portion 14a. Although this has no influence if the element size is small, the influence of the magnetic field from the protruding portion 14a due to the current is feared if the element size is small.

When the size of the junction surface is smaller than 0.5 μm×0.5 /μm, it is not possible to ignore the magnetic field due to the current applied to the free layer and the magnetic yokes from the pillar portion. In particular, the magnetic field due to the current has a great influence on the free layer and decreases the magnetic permeability of the free layer. The magnetic field due to the current also has a great influence on the off track characteristics of the yoke type magnetoresistance effect head.

Therefore, in this embodiment, the bottom face of the top electrode 14 is connected to the top face of the MR film 9, and this connected surface is defined by the shape of the MR film 9. The bottom face 26 of the top electrode 14 is greater than the junction face 27. The bottom face 26 of the top electrode 14 is herein defined by the surface of the top electrode 14 on the side of the medium facing surface, and the top face of the MR film 9 is defined by the opposite surface to the medium facing surface. Furthermore, as the material of the electrode, a monolayer or stacked film of Cu, Au, Ta or W having a low resistance is used.

Thus, in this embodiment, the area of the bottom face 26 of the top electrode 14 is greater than the area (i.e., junction area) of the top face of the MR film 9. Any portions corresponding to the pillar portion are not formed on the top electrode. Therefore, the magnitude of the magnetic field applied to the free layer 9e and the magnetic yokes 3 is given by the integral of the magnetic field in a direction perpendicular to the junction surface between the top electrode 14 and the MR film 9 (in the length direction of the pillar portion), so that the magnetic field, which has been conventionally generated from the pillar portion during the application of a current, can be reduced by omitting the pillar portion. Thus, as compared with conventional magnetic heads, the magnetic head in this embodiment can reduce the bad influence of the above described magnetic field on the magnetic anisotropy control of the magnetic yokes 3 and the free layer 9e of the MR film 9, so that it is possible to improve the proportion of noises to output signals (S/N ratio). In this embodiment, as will be described later, the area of the free layer 9e is set so as to be greater than the area of the pin layer 9c. Thus, the overlapping portion of the magnetic yokes 3 with the free layer 9e increases, and reluctance in the magnetic pass formed by the magnetic yokes 3 and the free layer 93 lowers, so that it is possible to improve the magnetic flux efficiency.

In the current perpendicular to plane type MR film 9 in this embodiment, a sense current having a converted current density of about 50 MA/cm² can be applied. In the case of this sense current, a magnetic field due to the current of about 50-1000 e is generated from the pillar portion to the free layer in conventional magnetic heads, whereas the above-described magnetic field can be reduced in this embodiment. The sense current value is preferably less than about 30 MA/cm², so that it is possible to ignore the influence of the magnetic field due to the sense current.

As shown in FIG. 21, in the yoke type magnetic head in this embodiment, no pillar portion is formed as described above. Therefore, the sense region of the MR film 9 is defined by the shape of the MR film 9. The top electrode 14 is connected directly to the MR film 9 via no pillar portion. The area of the contact surface of the top electrode 14 to the MR film 9 is equal to the area of the top face of the MR film 9. The area of the bottom face of the top electrode 14 is preferably greater than the outline of the magnetic yoke 3. In particular, the width of the top electrode 14 in track cross directions is not preferably less than the width Wy3 of the magnetic yoke 3. Thus, it is possible to decrease the influence of the magnetic field due to the current in the opposite direction to the magnetic flux penetrating direction, which is generated from the end portion of the top electrode 14 in track cross directions.

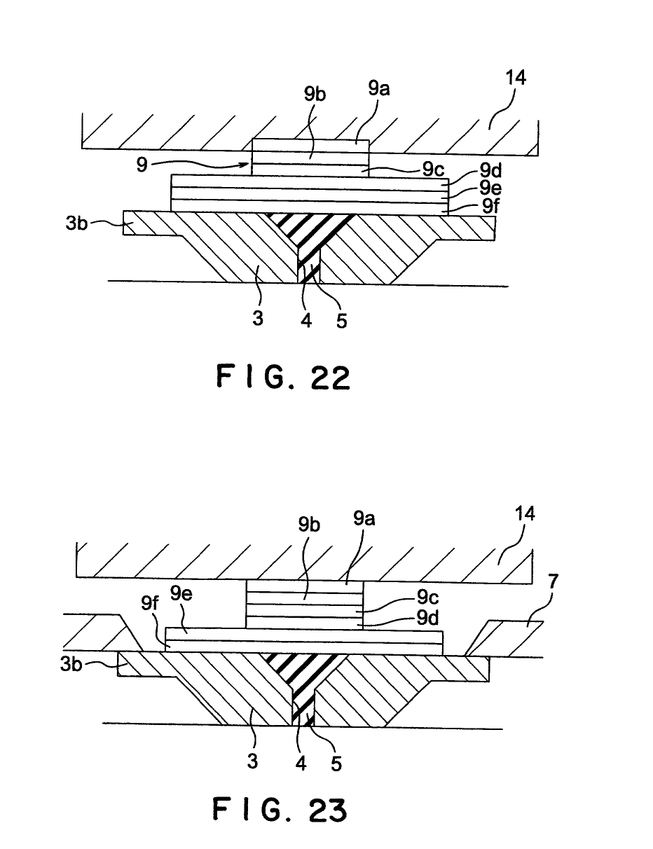

In this embodiment, the area of the free layer 9e is greater than the area of the pin layer 9c as shown in FIGS. 21 and 22. Therefore, the sense portion of the MR film 9 is defined by the pin layer 9c, and the connected surface to the top electrode 14 is defined by the area of the cap layer 9a which is the uppermost layer of the MR film 9, or the underlayer 9f.

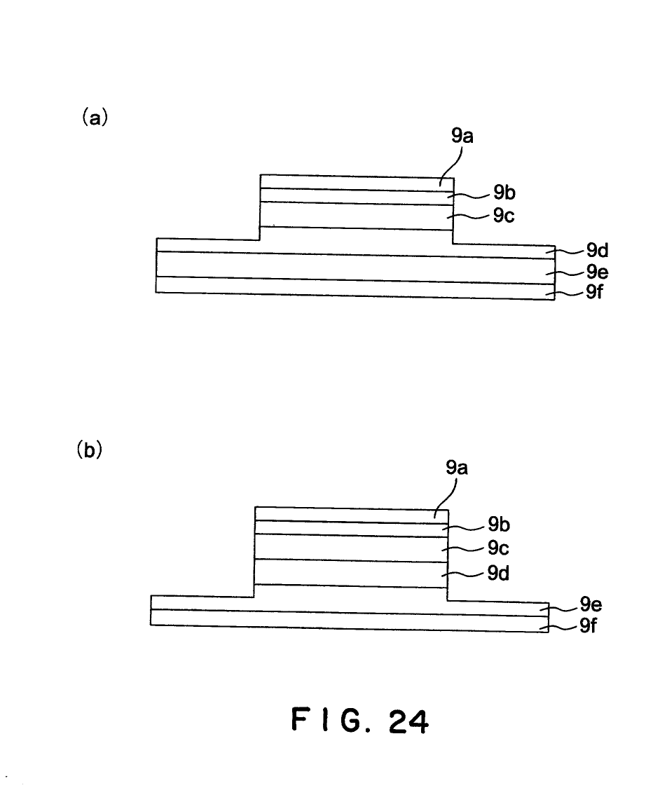

In this embodiment, the layers 9a and 9b formed after the formation of the pin layer 9c are batch-formed simultaneously with the pin layer 9c, and substantially have the same size as shown in FIG. 21. As will be described later, as shown in FIG. 23, the layers to the spacer layer 9d may be batch-processed. As shown in FIGS. 24(a) and 24(b), the definition may be completed on the way of the spacer layer 9d or on the way of the free layer 9e. In all of the above-described cases, the sense region is defined by the pin layer 9c.

With respect to the pin layer 9c, the end portion (x=±Wp/2) in cross directions is defined so as to be beyond the range of the end portion (x=±(Wy1)/2) of the tip portion 3a of the magnetic yoke, and is defined in a region which is not higher than the end portion (x=±(Wy3)/2) of the wing portion 3b of the magnetic yoke 3 in cross directions. In addition, the end portion (y=±Lp/2) is defined in a region which is a range of the end portion (y=±(ly2)/2) of the tip portion 3a of the magnetic yoke 3. The respective symbols are shown in FIG. 21.

If the end portion of the pin layer 9c in cross directions is defined so as to be beyond the range of the end portion (x =±(Wy1)/2) of the tip portion 3a of the magnetic yoke 3 in cross directions and within the range of the end portion (x=±(Wy3)/2) of the wing portion 3b of the magnetic yoke 3 in cross directions, the influence of the magnetic field applied to the most sensitive free layer 9e in the magnetic flux penetrating direction decreases, so that the influence of the magnetic field due to the current, which is generated from the pin layer 9c and the cap layer 9a on the free layer 9e can be minimum. The free layer 9e is anisotropy-controlled (biased) by the hard film in track cross directions, so that the vicinity of the end portion of the free layer 9e in track cross directions is a signal magnetic flux insensible region. Therefore, by defining the pin layer 9c to be in the above-described range, the magnetic field due to the current is applied to the insensible portion of the free layer 9e, so that the magnetic field due to the current has no influence on actual sensitivity.

By defining the end portion (y=±Lp/2) of the pin layer 9c in longitudinal directions to be within the region in the range of the end portion (y=±(Ly2)/2) of the tip portion 3a of the magnetic yoke 3, it is possible to avoid the magnetization unstable region or insensible region of the free layer 9e, so that it is possible to suppress the influence of magnetization rotation causing noises. Noises from the magnetic yoke 3 are also reduced.

The pin layer 9c is formed on the magnetic gap 4. By defining the pin layer 9c to be in the above-described range, a sense current is applied only to a portion, in which the magnetization rotation of the free layer 9e is large when a signal magnetic flux flows into the free layer 9e, via the pin layer 9c. Therefore, it is possible to obtain a great output. If the pin layer 9c is defined to be within the magnetization unstable region of the free layer 9e, noises are caused, and S/N deteriorates.

With respect to the free layer 9e, the end portion (y=±Lf/2) in longitudinal directions and the end portion (x=±Wf/2) in cross directions are defined to be regions beyond the range of the end portion y=±(Ly2)/2and beyond the range of the end portion x=±(Wy2)/2, respectively.

In this embodiment, the area of the free layer 9e is greater than the area of the pin layer 9c, so that the overlapping portion of the magnetic yokes 3 with the free layer 9e increases. Therefore, reluctance in the magnetic path formed by the magnetic yokes 3 and the free layer 9e lowers, so that it is possible to improve the signal magnetic flux efficiency. In addition, since the area of the pin layer 9c is smaller than the area of the free layer 9e, the pin layer 9c can be formed right above the magnetic gap 4, and a sense current can be supplied only to a portion in which the magnetization rotation of the free layer 9e is sufficiently large, so that the output of the magnetic head is improved.

Sixteenth Embodiment

The construction of the sixteenth embodiment of a yoke type magnetic head according to the present invention is shown in FIG. 22. In the magnetic head in this sixteenth embodiment, the cap layer 9a of the MR film 9 is embedded in the top electrode in the magnetic head in the fifteenth embodiment. Thus, it is possible to reduce the magnetic field which is generated from the pin layer 9c and the cap layer 9a. Moreover, since the contact area of the MR film 9 to the top electrode 14 increases, it is possible to reduce the contact resistance. Furthermore, in this embodiment, the magnetic gap 4 is filled with the insulating film 5.

Also in the magnetic head in this sixteenth embodiment, it is possible to prevent the magnetic flux efficiency from lowering, and it is possible to improve S/N ratio.

While the cap layer 9a has been embedded in the top electrode 14 in this embodiment, portions reaching half of the pin layer 9c may be embedded in the top electrode 14.

Seventeenth Embodiment

The construction of the seventeenth embodiment of a yoke type magnetic head according to the present invention is shown in FIG. 23. In the magnetic head in this seventeenth embodiment, the spacer layer 9d is also formed so as to have the same shape as those of the cap layer 9a the antiferromagnetic layer 9b and the pin layer 9c in the magnetic head in the fifth embodiment. The bottom electrode 7 is formed on the wing portion 3b of the magnetic yoke 3, and the magnetic gap 4 is filled with the insulating film 5.

Also in the magnetic head in this seventeenth embodiment, it is possible to prevent the magnetic flux efficiency from lowering, and it is possible to improve S/N ratio.

Eighteenth Embodiment

Referring to FIGS. 24(a) and 24(b), the eighteenth embodiment of a yoke type magnetic head according to the present invention will be described below. FIGS. 24(a) and 24(b) show the cross sections of an MR film 9 of the magnetic head in the eighteenth embodiment. In the MR film 9 of the magnetic head in the eighteenth embodiment, a part of the spacer layer 9d may be formed so as to have the same shape as those of the cap layer 9a the antiferromagnetic layer 9b and the pin layer 9c as shown in FIG. 24(a), or a part of the free layer 9e may be formed so as to have the same shape as those of the cap layer 9a the antiferromagnetic layer 9b, the pin layer 9c and the spacer layer 9d as shown in FIG. 24(b), in the MR film 9 of the magnetic head in the seventeenth embodiment.

Even if such an MR film 9 is used, it is possible to prevent the magnetic flux efficiency from lowering, and it is possible to improve S/N ratio, similar to the seventeenth embodiment.

Nineteenth Embodiment

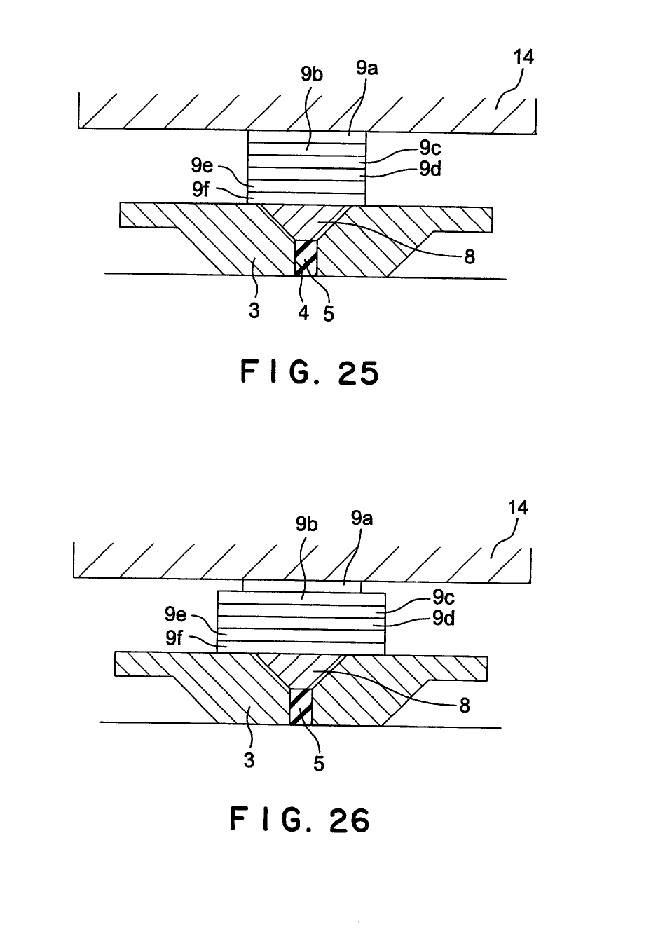

The construction of the nineteenth embodiment of a yoke type magnetic head according to the present invention is shown in FIG. 25. In the magnetic head in this nineteenth embodiment, the cap layer 9a antiferromagnetic layer 9b, pin layer 9c, spacer layer 9d, free layer 9e and underlayer 9f constituting the MR film 9 in the magnetic head in the fifteenth embodiment shown in FIG. 21 are formed so as to have the same shape. In addition, a conductor 8 is filled in a magnetic gap 4 so as to be connected to the underlayer 9f, and an insulator 5 is filled in the magnetic gap 4 on the side of the medium facing surface.

In this embodiment, all of the uppermost to lowermost layers of the MR film 9 are simultaneously defined. Therefore, there is an advantage in that the influence of a magnetic field on the free layer 9e due to the current can be decreased.

Twentieth Embodiment

The construction of the twentieth embodiment of a yoke type magnetic head according to the present invention is shown in FIG. 26. In the magnetic head in this twentieth embodiment, the antiferromagnetic layer 9b, pin layer 9c, spacer layer 9d, free layer 9e and underlayer 9f constituting the MR film 9 in the magnetic head in the nineteenth embodiment shown in FIG. 25 are formed so as to have the same shape, and the cap layer 9c is formed so as to be smaller than other layers. Thus, even if portions reaching the pin layer 9c are not batch-processed, a sense current can be concentrated on a signal magnetic flux sensing region, so that it is possible to improve S/N ratio.

Twenty-First Embodiment

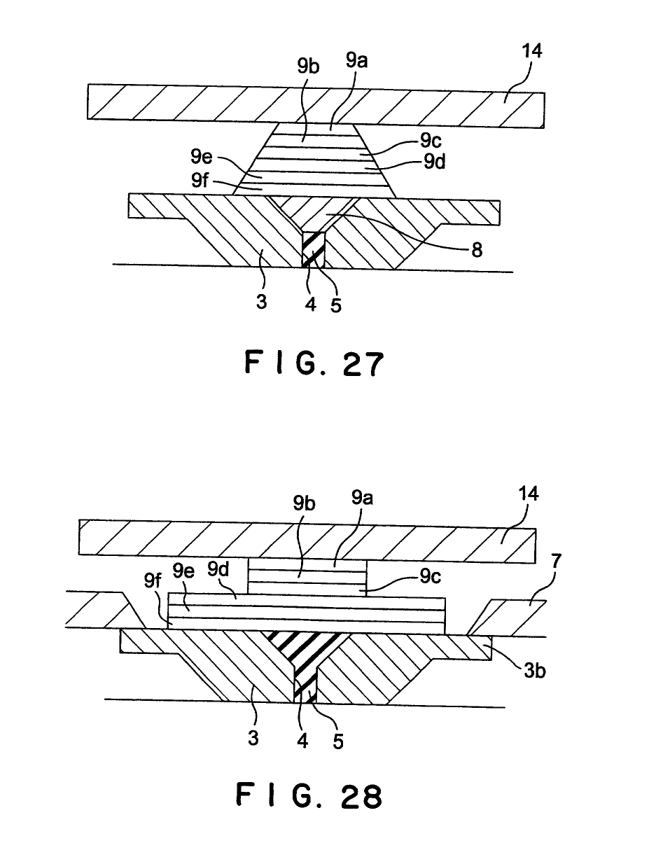

The construction of the twenty-first embodiment of a yoke type magnetic head according to the present invention is shown in FIG. 27. In the magnetic head in this twenty-first embodiment, the cap layer 9a antiferromagnetic layer 9b, pin layer 9c, spacer layer 9d, free layer 9e and underlayer 9f constituting the MR film 9 in the magnetic head in the nineteenth embodiment shown in FIG. 25 are formed so that the areas thereof continuously decrease from the lowermost underlayer 9f to the uppermost cap layer 9a. That is, the side of the MR film 9 is inclined at a certain angle from the cap layer 9a to the underlayer 9f. The area of the uppermost face of the magnetoresistance effect element 9 is smaller than the area of the lowermost face thereof. Thus, a sense current can be concentrated only on a high sensitive sense region right above the magnetic gap, so that it is possible to improve S/N ratio.

Twenty-Second Embodiment

The construction of the twenty-second embodiment of a yoke type magnetic head according to the present invention is shown in FIG. 28. In the magnetic head in this twenty-second embodiment, the bottom electrode 7 is provided on the wing portion 3b of the magnetic yoke 3 in the magnetic head in the fifteenth embodiment shown in FIG. 21. Therefore, a current is applied so as to be substantially parallel to bit length directions. Thus, the magnetic yoke 3 and the free layer 9e are magnetic-anisotropy-controlled in track cross directions. In addition, by applying a current to the magnetic yoke 3 as this embodiment, the magnetic field due to the current applied to the magnetic yoke 3 is reduced. In this embodiment, a sense current is applied to the bottom electrode 7, which is connected to the magnetic yoke 3, via the MR film 9 and the magnetic yoke 3. Furthermore, reference number 5 denotes an insulator.

Twenty-Third Embodiment

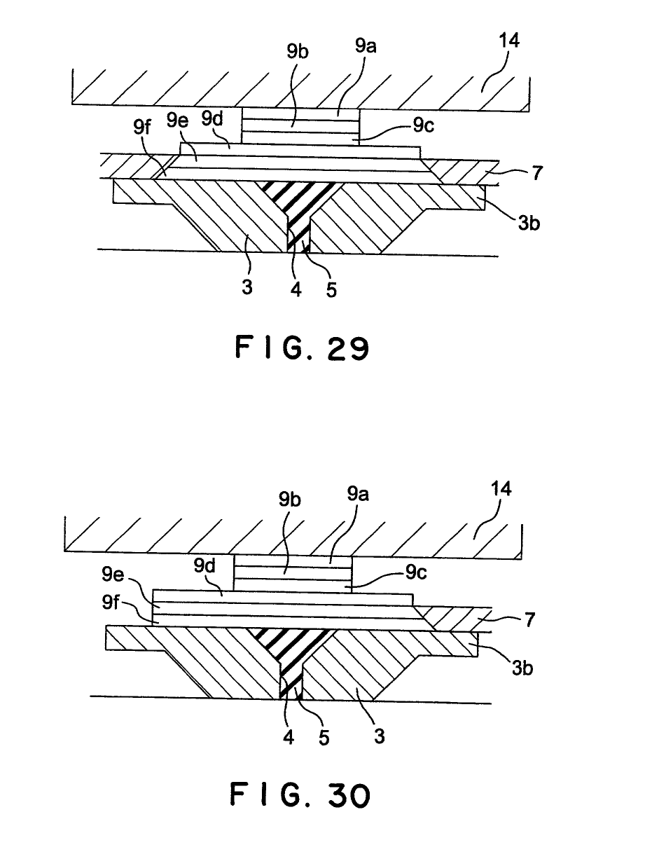

The construction of the twenty-third embodiment of a yoke type magnetic head according to the present invention is shown in FIG. 29. In the magnetic head in this twenty-third embodiment, the bottom electrode 7 is connected to both of the free layer 9e and the underlayer 9f in the magnetic head in the twenty-second embodiment shown in FIG. 28. As compared with the twenty-second embodiment, the bottom electrode 7 is formed so as not to contact the spacer layer 9d.

Twenty-Fourth Embodiment

The construction of the twenty-fourth embodiment of a yoke type magnetic head according to the present invention is shown in FIG. 30. In the magnetic head in this twenty-fourth embodiment, the output of the top electrode 14 and bottom electrode 7 in the magnetic head in the twenty-third embodiment shown in FIG. 29 is extracted in a bit length direction on one side. Thus, the magnetic field applied to the magnetic yoke 3 and the free layer 9e is strongly applied only in one direction of track cross directions. Therefore, since only a weak magnetic field due to the current is applied to the magnetic yoke 3 and the free layer 9e on the side on which the electrodes 7 and 14 are not covered, it is easy to carry out the magnetic anisotropy control of the magnetic yoke 3, so that it is possible to prevent the magnetic permeability of the magnetic yoke 3 and free layer 9e themselves from lowering.

Furthermore, in the magnetic heads in the twenty-second through twenty-fourth embodiment, the bottom electrode 7 is formed so as to be wider than the magnetic yoke 3 in order to lower the resistance. Moreover, in order to decrease the contact resistance, the total area of the contact face to the magnetic yoke 3 is preferably set as large as possible.

Twenty-Fifth Embodiment

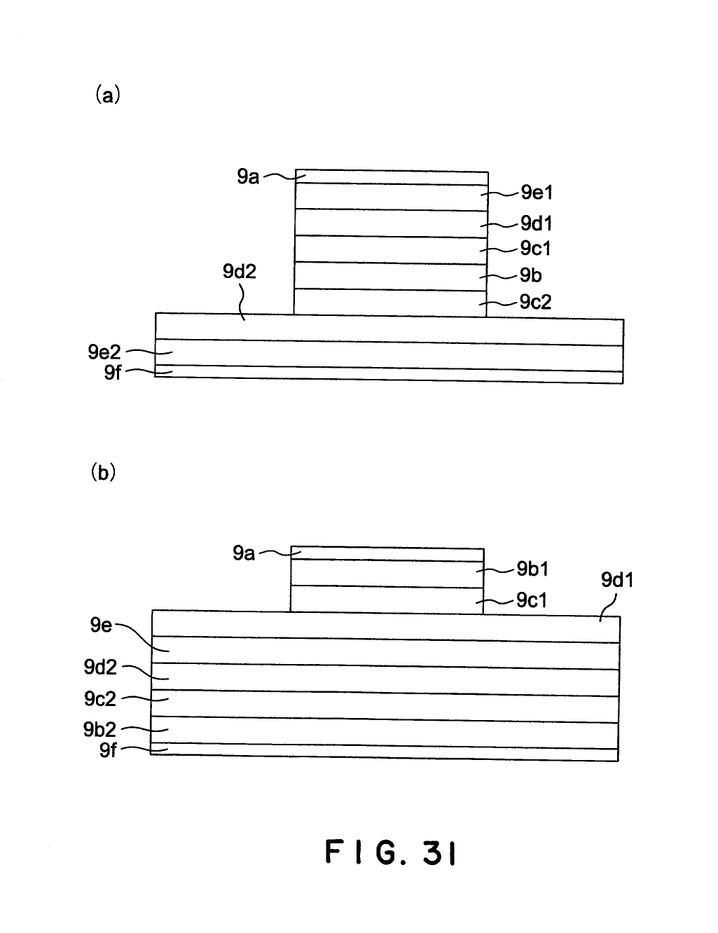

Referring to FIGS. 31(a) and 31(b), the twenty-fifth embodiment of a yoke type magnetic head according to the present invention will be described below. FIGS. 31(a) and 31(b) shows the cross sections of an MR film 9 of the magnetic head in the twenty-fifth embodiment. The MR film 9 of the magnetic head in the twenty-fifth embodiment may be formed so as to have a dual free layer as shown in FIG. 31(a), or may be formed so as to have a dual pin layer as shown in FIG. 31(b). The MR layer 9 shown in FIG. 31(a) comprises a cap layer 9a a free layer 9e1, a spacer layer 9d1, a pin layer 9c1, an antiferromagnetic layer 9b, a pin layer 9c2, a spacer layer 9d2, a free layer 9e2 and an underlayer 9f. The MR film 9 shown in FIG. 31(b) comprises a cap layer 9a an antiferromagnetic layer 9b1, a pin layer 9c1, a spacer layer 9d1, a free layer 9e, a spacer layer 9d2, a pin layer 9c2, an antiferromagnetic layer 9b2 and an underlayer 9f. In the MR film shown in FIG. 31(b), a main sense region is defined by the pin layer 9c1 on one side.

Twenty-Sixth Embodiment

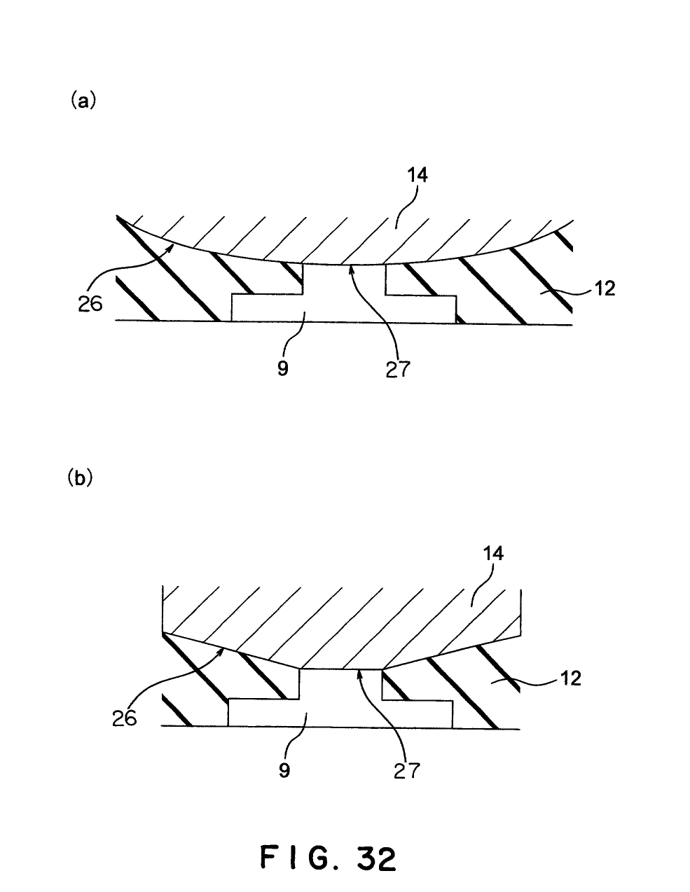

The construction of the twenty-sixth embodiment of a yoke type magnetic head according to the present invention is shown in FIG.32. In the magnetic head in this twenty-sixth embodiment, the bottom face 26 of the top electrode 14 in the fifteenth embodiment shown in FIG. 21 is curved as shown in FIG. 32(a). Furthermore, portions of the bottom face 26 of the top electrode 14 other than a junction face 17 are preferably inclined at a certain angle as shown in FIG. 32(b). With this construction, it is possible to greatly reduce the insulation failure occurring between the magnetic yoke 3 and the top electrode 14. In the magnetic head in this twenty-sixth embodiment similar to the fifteenth embodiment, it is possible to prevent the magnetic flux efficiency from lowering, and it is possible to improve S/N ratio.

Furthermore, the shape of the bottom face of the top electrode 14 in the twenty-sixth embodiment can be obtained by etching an insulating film, such as SiOₓ or AlOₓ, using the RIE (reactive-ion-etching) or CDE (chemical-dry-etching).

Twenty-Seventh Embodiment

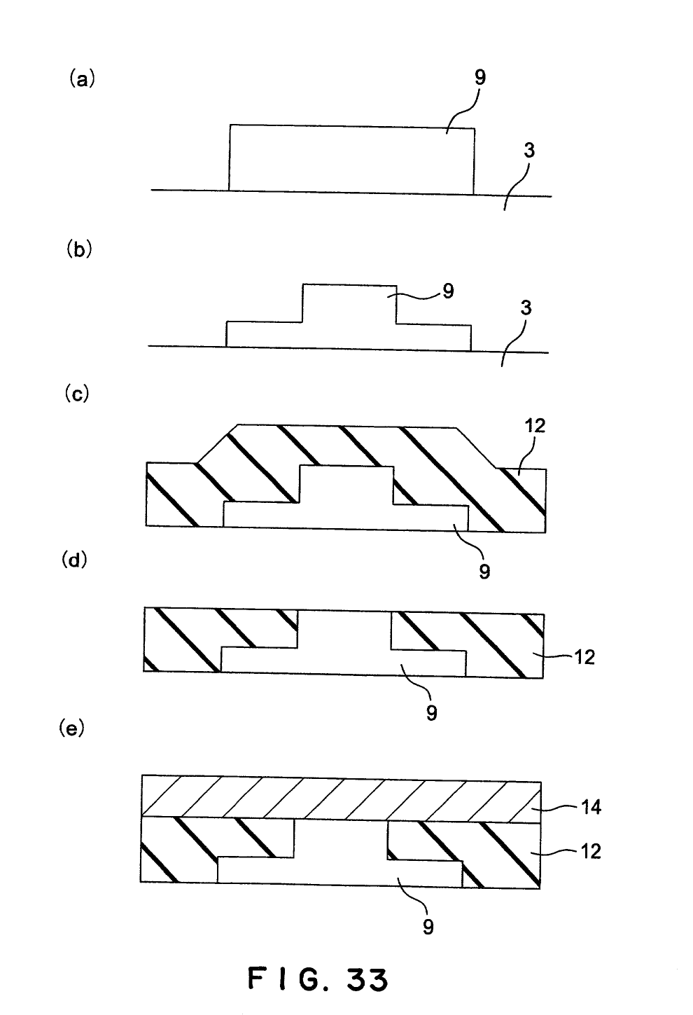

Referring to FIG. 33, the twenty-seventh embodiment of the present invention will be described below. This twenty-seventh embodiment relates to a method for fabricating a horizontal yoke type magnetic head, and the fabricating steps thereof are shown in FIG. 33.

First, as shown in FIG. 33(a), an MR film 9 is deposited on a processed magnetic yoke 3. Thereafter, a lithography step, an etching step and a resist removing step are carried out, and the outline of the MR film 9 is patterned on the magnetic yoke 3 (see FIG. 33(a) ).

Then, as shown in FIG. 33(b), a lithography step and an etching step are carried out, and a processing for defining a junction face of the MR film to a top electrode is carried out. Furthermore, in this embodiment, the etching is stopped until all of the free layer is chipped after the etching of a pin layer is completed as described above.

Then, as shown in FIG. 33(c), an insulating film 12 of an oxide film, such as an AlOₓ or SiOₓ, or a nitride film is deposited. Thereafter, as shown in FIG. 33(d), the surface of the insulating film 12 is flattened using the CMP (chemical-mechanical-polishing) or an etching step utilizing an etching rate difference, to expose the junction face of the surface of the MR film 9 (Top Exposing Step).

Then, as shown in FIG. 33(e), Cu which is the material of the top electrode is deposited on the whole surface, and thereafter, the top electrode is patterned.

If the method for thus fabricating a magnetic head in this embodiment is used, the bottom face of the top electrode 14 is substantially parallel to the top face of the MR film 9 on the same plane.

Twenty-Eighth Embodiment

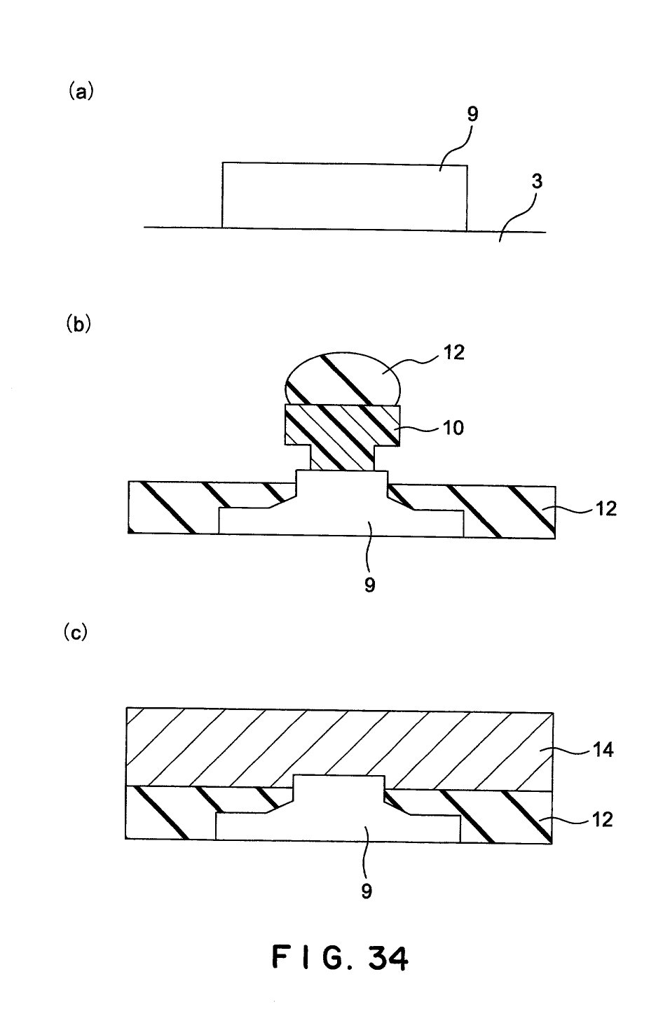

Referring to FIG. 34, the twenty-eighth embodiment of the present invention will be described below. This twenty-eighth embodiment relates to a method for fabricating a horizontal yoke type magnetic head, and the fabricating steps thereof are shown in FIG. 34. In the fabricating method in this embodiment, a part of the uppermost end of the MR film 9 can be embedded in the top electrode 14 as shown in FIG. 22. The embedded amount can be controlled by the deposited thickness of the insulator 12.

First, as shown in FIG. 34(a), an MR film 9 is deposited on a processed magnetic yoke 3. Thereafter, a lithography step, an etching step and a resist removing step are carried out, and the outline of the MR film 9 is patterned on the magnetic yoke 3 (see FIG. 34(a) ).

Then, as shown in FIG. 34(b), a lithography step and an etching step are used for carrying out a processing for defining a junction face of the MR film to a top electrode 14. Subsequently, a resist 10 is applied thereon to be patterned so as to define the shape of the junction face. At this time, an inversely tapered resist or a T-shaped resist shown in the figure is used as the resist 10. Thereafter, the MR film 9 is etched. The finishing position of the etching is the same as that at the step shown in FIG. 34(b). Thereafter, as shown in FIG. 34(b), an insulating film 12 is deposited on the whole surface. Then, the resist 10 is removed to simultaneously remove the insulating film on the junction face.

Then, similar to the step shown in FIG. 33(e), Cu which is the material of the top electrode is deposited, and thereafter, the film of the material of the top electrode is patterned to form the top electrode 14 (see FIG. 34(c)).

Before describing the twenty-ninth through thirty-third embodiments of a yoke type magnetic head according to the present invention, problems of conventional yoke type magnetic heads will be described below.

As the magnetic packing density increases, the track width decreases, so that energy stored in the medium decreases. If the track width decreases to decrease energy stored in the medium, the quantity of the magnetic flux generated therefrom also decreases. As a result, a sufficient quantity of the magnetic flux can be only supplied to a very small magnetic path. In a magnetoresistance effect film, a region contributing to the variation in resistance is a region through which a signal magnetic flux passes. Other portions are useless current paths to deteriorate the S/N ratio of the magnetoresistance effect film. Therefore, the current applied region in the magnetoresistance effect should be limited to about the region through which the signal magnetic flux passes. However, if the size of the magnetoresistance effect film is about 0.1 to 0.2 μm, there is a problem in the alignment of a reproducing/reading gap with the magnetoresistance effect element, so that the deterioration of yields is caused. The technique for avoiding this is disclosed in Japanese Patent Laid-Open No. 10-83522. In this technique, a magnetoresistance effect film is patterned using a magnetic gap, which is formed thereon at a thin-film deposition step, as a mask, so that the magnetic gap and the magnetoresistance effect film are processed so as to be self-aligned.

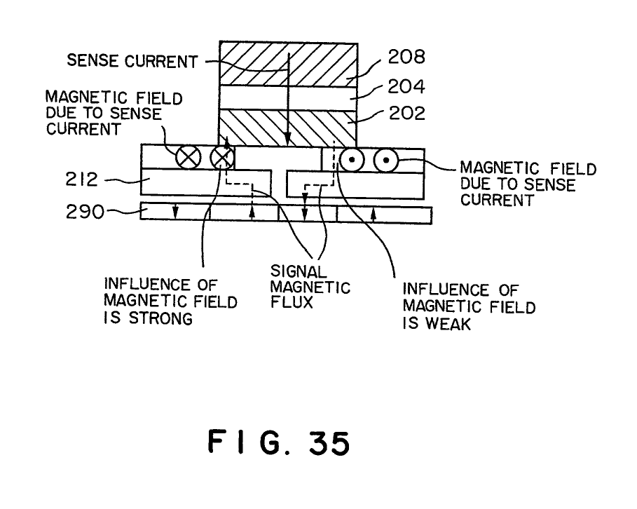

On the other hand, in a TMR element and CPP-GMR element wherein the variation in high resistance can be expected since a sense current flows in a direction perpendicular to a film stacked interface, a magnetic field due to the sense current is induced on a yoke face since a current is applied perpendicularly to the yoke face, so that the bias design of the yoke is complicated. Therefore, as shown in FIG. 35, in a magnetic head which comprises: a magnetoresistance effect element having an electrode 202, a current perpendicular to plane type magnetoresistance effect film 204 and an electrode 208; and a magnetic yoke 212 having a magnetic gap, if a sense current flowing through the electrode 202, the CPP-MR film 204 and the electrode 208 is shifted from the magnetic yoke 212, an induced galvano magnetic field is not symmetrical with respect to the magnetic gap. As a result, the yoke bias design is destroyed, and according to circumstances, Barkhausen noises based on the generation of magnetic domains may be generated. There is no problem in current in plane type magnetoresistance effect elements. The positional relationship between a pair of yokes and the magnetoresistance effect element must be particularly strict in current perpendicular to plane type magnetoresistance effect elements.

In order to ensure regeneration outputs, it is required to carry out a high efficiency design by shortening the length of a magnetic path or the like. For that purpose, a horizontal head capable of basically defining the length of a magnetic path by a great thickness is suitable. However, if the packing density exceeds 100 Gbpsi and the track width reaches about 0.1 μm, it is required to decrease the size of the magnetoresistance effect element to the same extent, so that there is a problem in that the position of the magnetic gap is shifted from the position of the magnetoresistance effect element. This may cause the deterioration of yields. An example of a method for avoiding this is disclosed in Japanese Patent Laid-Open No. 10-83552. In recent years, the lithography techniques including the electron beam lithography have a precision at which such a deterioration of yield can be prevented.

On the other hand, in the case of a high sensitive magnetoresistance effect element characterized by a current perpendicular to plane, the relationship between the center of a sense current and the position of the yoke is more important. That is, the current perpendicular to plane type magnetoresistance effect element and the pair of yokes must be arranged at the same distance. The position shift causes to generate an ununiform magnetic field due to the sense current in the yokes to cause Barkhausen noises and so forth.

In the twenty-ninth through thirty-third embodiments which will be described below, it is possible to prevent the lowering of the magnetic flux efficiency, and it is possible to prevent the deterioration of yield and the generation of Barkhausen noises.

Twenty-Ninth Embodiment

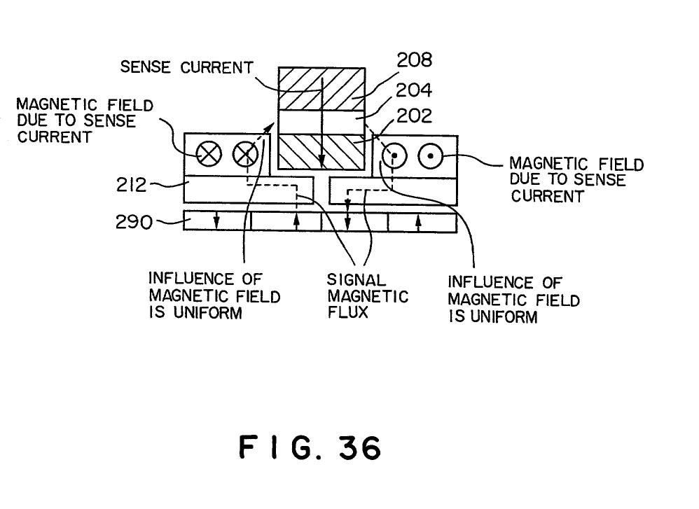

The construction of the twenty-ninth embodiment of the present invention is shown in FIG. 36. A yoke type magnetic head in this embodiment comprises: a current perpendicular to plane type magnetoresistance effect element having an electrode 202, a current perpendicular to plane type magnetoresistance effect film 204 and an electrode; and a magnetic yoke 212 having a magnetic gap. Furthermore, reference number 290 denotes a magnetic medium.

In the yoke type magnetic head in this embodiment, with respect to the positional relationship between the magnetoresistance effect element and the magnetic yoke 212, the most proximate magnetic yoke 212 is arranged substantially at the same distance from the center of a sense current in a region to which the sense current is applied perpendicularly to the film surface of the magnetoresistance effect element. This construction can be realized by self-aligning and embedding the magnetoresistance effect element in a recessed portion which is formed in the opposite surface of the magnetic yoke 212 to the medium facing surface. This construction can also be realized by causing the magnetic yoke 212 to be self-aligned to cover the magnetoresistance effect element.

With this construction, the influence of the magnetic field based on the sense current on the magnetic yoke 212 is uniform, so that it is possible to prevent Barkhausen noises from being generated. In addition, the magnetoresistance effect element and the magnetic yoke 212 are self-aligned to be formed, so that it is possible to prevent the deterioration of yields.

Thirtieth Embodiment

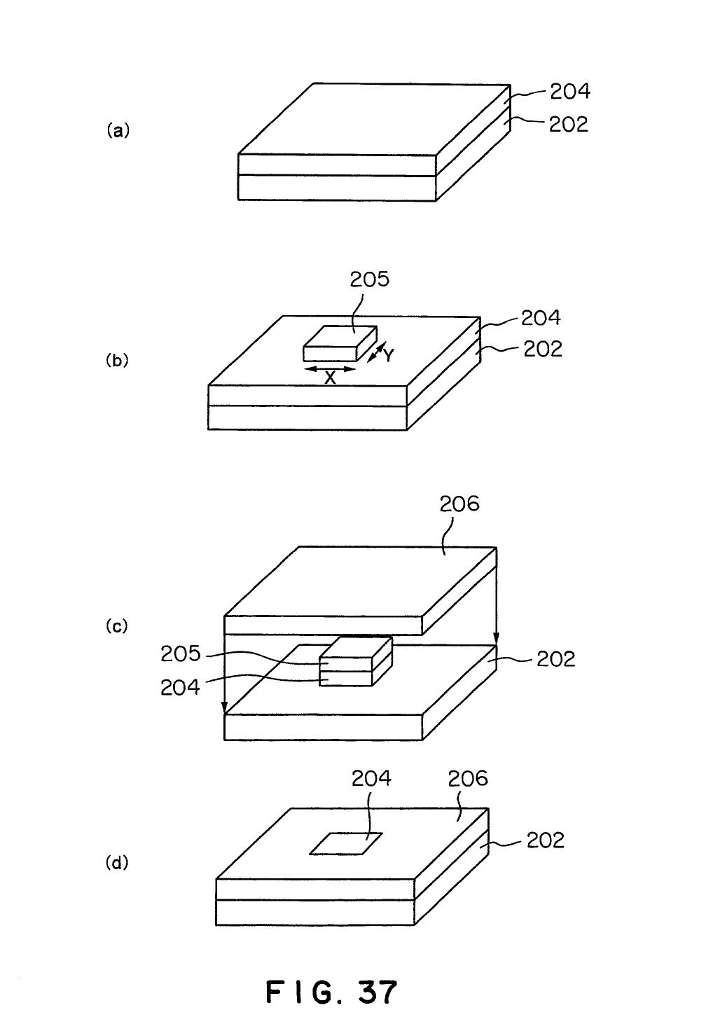

Referring to FIGS. 37 through 41, the thirtieth embodiment of the present invention will be described below. This thirtieth embodiment relates to a method for fabricating a yoke type magnetic head, and the fabricating steps thereof are shown in FIGS. 37 through 41. First, a film of, e.g., Cu, having a thickness of 50 nm is formed on an Si substrate (not shown), and a film of, e.g., Ta, having a thickness of 10 nm is formed on the Cu film as an electrode film 202 (see FIG. 37(a) ). Subsequently, a current perpendicular to plane type magnetoresistance effect film 204 (which will be also hereinafter referred to as a CPP-MR film 204) is formed on the electrode film 202 (see FIG. 37(a) ). These depositions are preferably continuously carried out in vacuum. Furthermore,the CPP-MR film 204 has a structure wherein a plurality of layers are stacked, e.g., wherein a CoFe layer having a thickness of 1 nm as the lowermost layer, a Cu layer having a thickness of 1 nm, a CoFe layer having a thickness of 1 nm, a Cu layer having a thickness of 1 nm, a CoFe layer having a thickness of 1 nm, a Cu layer having a thickness of 7 nm, a CoFe layer having a thickness of 1 nm, a Cu layer having a thickness of 1 nm, a CoFe layer having a thickness of 1 nm, a Cu layer having a thickness of 1 nm, a CoFe layer having a thickness of 1 nm, and a PtMn layer having a thickness of 15 nm are sequentially stacked. The CPP-MR film 204 may also be a TMR film.

Furthermore, when the CPP-MR film 204 is sequentially deposited in vacuum, it is not feared that an oxide film is formed on the surface of the electrode film 202. However, when the electrode film 202 is exposed to atmosphere after being deposited, it is required to sputter-clean the surface of the electrode film 202 by a few nanometers before forming the CPP-MR film 204. If not so, there is some possibility that a sense current flows to be concentrated on a region having a diameter of about 0.1 μm on the CPP-GMR film 204 to increase the contact resistance to deteriorate the S/N ratio of the magnetoresistance effect element.

However, excessive sputter-cleaning induces a rough surface to deteriorate magnetoresistance effect characteristics. Therefore, a sputter-cleaning of 2-5 nm is desired. In this embodiment, a Ta film having a thickness of 10 nm was formed, and a sputter-cleaning of 3 nm was carried out. Furthermore, since it is desired on characteristics of the CPP-MR element that the surface after the sputter-cleaning has a surface roughness Rmax of less than 5 nm, it is desired that the surface is flattened by the CMP (chemical mechanical polishing) or the like before the sputter-cleaning after forming the electrode film 202. This flattening may be carried out for the Ta film which is the electrode uppermost layer, or the Ta layer may be formed after the Cu layer is flattened. However, in view of the fact that scratches are easy to enter due to softness of the material, the surface of the Ta film is preferably flattened. The CMP is preferably carried out immediately after deposition so that the CMP is carried out for the whole surface of the wafer by the same material.

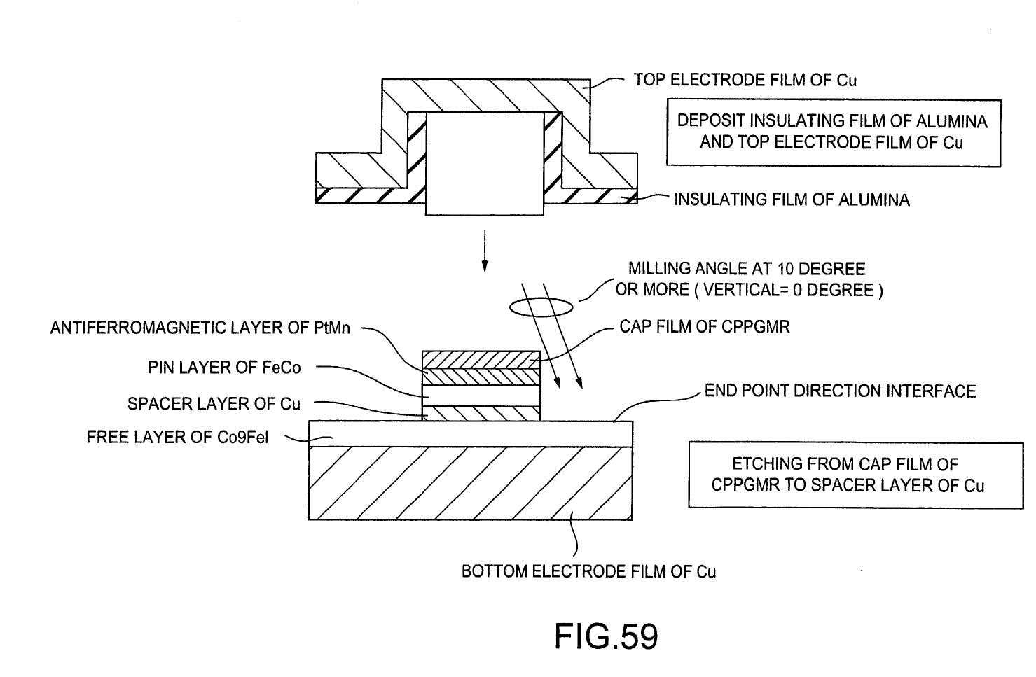

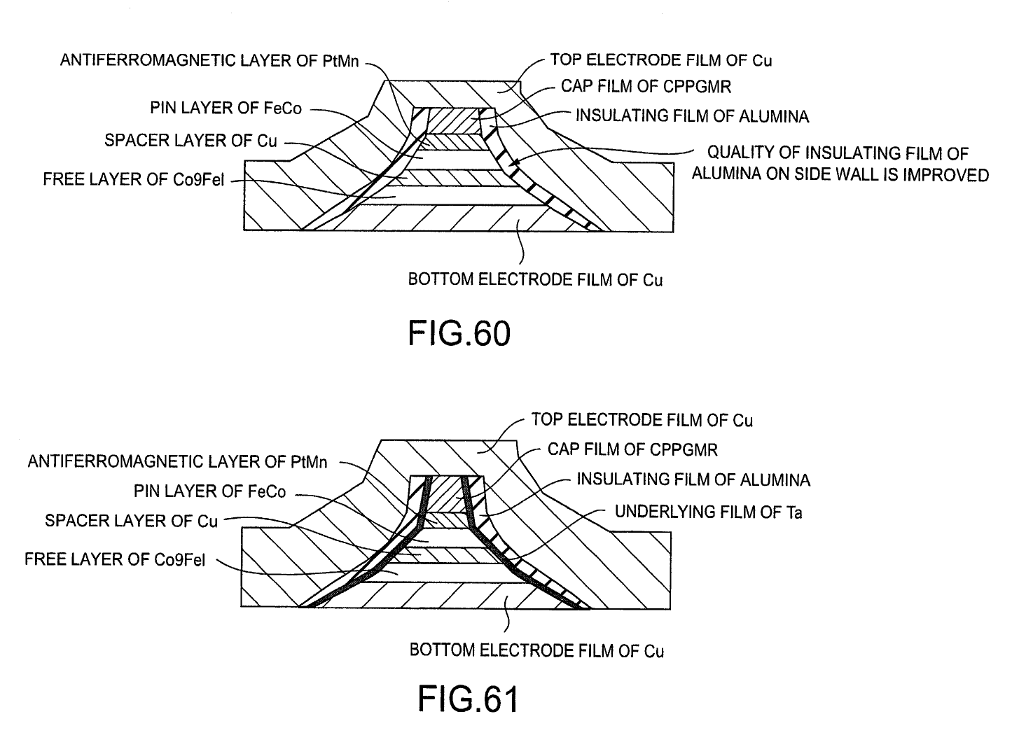

Then, a photoresist is applied on the CPP-MR film 204 to be patterned to form a resist pattern 205 having a rectangular parallelepiped shape having a length of 0.15 μm in X directions and a length of 0.4 μm in Y directions (see FIG. 37(b)). In this case, the interface between the film (e.g., CoFe film) of the lowermost layer of the CPP-MR film 204 and the Ta film on the surface of the electrode 202 was used as an end point detection (EPD) interface. As the EPD interface, the SIMS (Secondary Ion Mass Spectroscopy) was used. It is required to pattern the CPP-MR film 204 using the ion milling. Moreover, the thickness of the CPP-MR film 204 is greater than that of a current in plane type magnetoresistance effect film (which will be also hereinafter referred to as a CIP-MR film) by about 10 nm, and an over milling is carried out with respect to a gap film below alumina in the in-plane shielded head, whereas the over milling is carried out with respect to the surface of the electrode such as the Ta film in the CPP-MR film 204, so that there is some possibility that the over milling quantity on the surface of the electrode 2 increases due to the difference between milling rates. Therefore, it is desired to use a milling apparatus adopting the EPD interface using the SIMS and/or optical technique. The thickness of the Ta film formed on the surface of the electrode 202 is preferably 5 nm or more in view of 2 nm for the above described sputter-cleaning and 3 nm for the over milling. If it also serves as the layer underlying the CPP-MR film 204, assuming that the thickness of the underlayer of Ta of the CPP-MR film 204 is Z1 nanometers and that the thickness of the Ta film on the surface of the electrode 202 after the CMP is Z2 nanometers, it is preferably designed that Z1+Z2 >5 nanometers. In addition, as shown in FIG. 59, this patterning has merits if it is stopped on the top face of the free layer of the CPP-MR film 204. Thus, the sense current spreads in the free layer, so that it is possible to decrease the influence of the magnetic field due to the sense current on the free layer bias. In this case, as shown in FIG. 59, the Cu/CoFe interface is a detection interface. In addition, it is desired that the ion milling is carried out at 300 eV or less in order to reduce the influence of Ar ion implantation on the free layer, and it is desired that ions are incident at an inclined angle of 10 degrees or more so as to suppress the gouging due to elastic scattering Ar and so as to carry out milling at a smooth angle. Although the cross section of the patterned free layer is preferably flat, it may have a gentle taper. An example thereof is shown in FIG. 60. If the slope of the side wall of the element is gentle, there is an advantage in that the quality of the whole surface of an insulating film 206 (see FIG. 37(c)) of alumina or the like formed on the side wall is good, so that insulation from a top electrode, which is formed on the CPP-MR film 204 and which will be described later, is good.

Then, as shown in FIG. 37(c), an insulating film 206 of, e.g., alumina, substantially having the same thickness as that of the CPP-MR film 204 is formed on the whole surface, and thereafter, the resist pattern is removed, i.e., lifted off (see FIG. 37(c)). Then, as shown in FIG. 37(d), the whole surface of the CPP-MR film 204 is covered with the insulating film 206 except for the top face thereof.

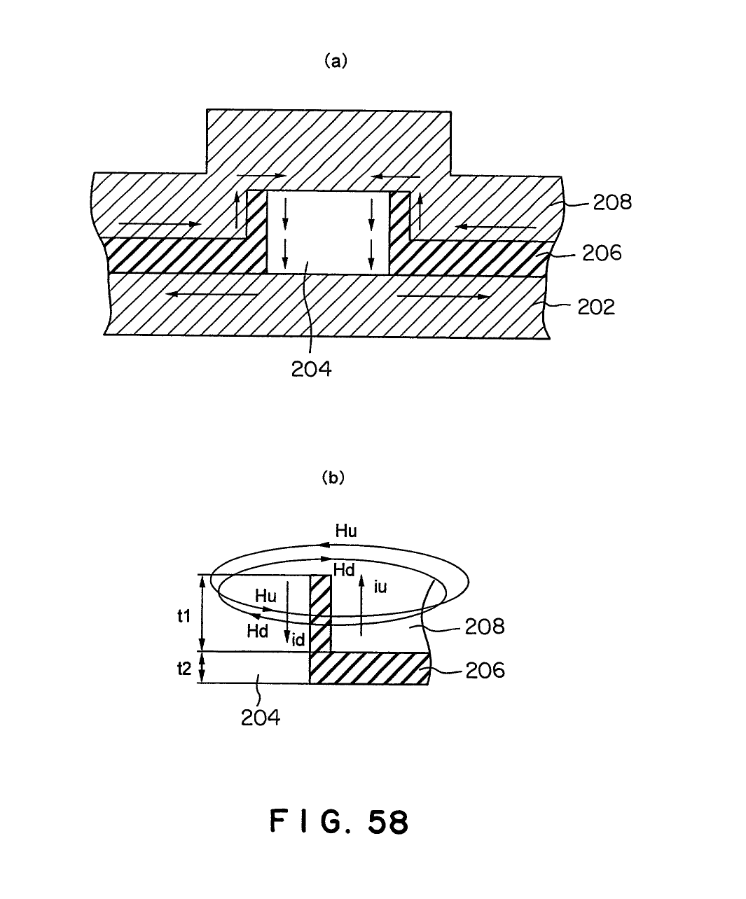

Furthermore, if the insulating film 206 is too thin, the insulation of the top electrode, which is formed on the CPP-MR film 204 and which will be described later, from the bottom electrode 202 is insecure. On the other hand, if the insulating film 206 is too thick, the current applied distance in a direction perpendicular to the plane extends, so that the influence of the magnetic field due to the sense current appears. Therefore, it is desired that the thickness of the insulating film 206 is set as thin as possible (is thinner than the thickness of the CPP-MR film 204 if possible). In order to obtain a thin film having a secure quality, an underlayer may be arranged below the insulating film 206. For example, since the surfaces of the respective layers having the above described gentle taper are made of the same metal by introducing a single metal underlayer of Ta as shown in FIG. 61, the adhesion and quality of the alumina insulating film are improved, so that the insulating characteristics of the top and bottom electrodes are improved. If the thickness of the insulating film 206 is smaller than the etching depth, the sense current flowing through the top electrode has a component in the opposite vertical direction to that of the sense current flowing through the CPP-MR film 204. Thus, it is possible to reduce the induced magnetic field in directions on the plane of the CPP-MR film 204. That is,as shown in FIG. 58, a magnetic field Hu induced by an upward current iu, and a magnetic field Hd induced by a downward current id extend in the opposite directions to each other to be canceled. Therefore, it is possible to cancel a magnetic field due to the current generated from a portion corresponding to a thickness t1 of the thickness (=t1+t2) of the CPP-MR film 204. Furthermore, a magnetic field due to the current generated from a portion corresponding to a thickness t2 remains.

If a vertical bias applying magnetically hard film or antiferromagnetic film is first deposited on the free layer of the CPP-MR film 204 and if the insulating film 20 of alumina is stacked thereon, it is possible to obtain both of the biasing to the CPP-MR film 204 and the insulation from the top electrode. In order to make the surfaces of the same material, it is important to use an underlying film as the above-described vertical bias film.

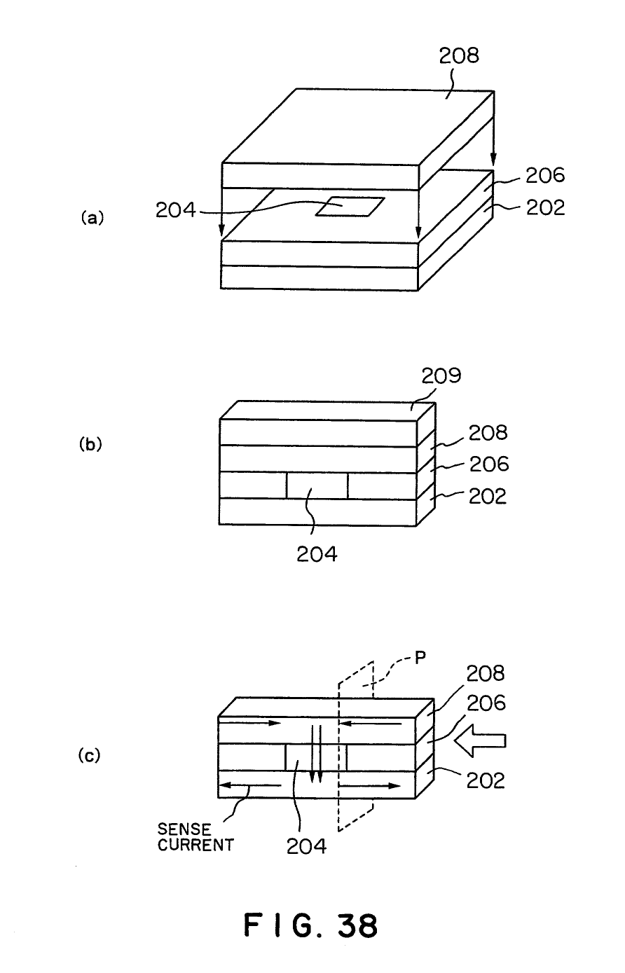

Then, as shown in FIG. 38(a), an electrode film 208 of, e.g., Cu, having a thickness of 20 nm is formed on the insulating film 206. This electrode film 208 serves to form atop electrode. In order to reduce the contact resistance of the electrode film 208 to the CPP-MR film 204 in a very small area, it is required to sufficiently sputter-clean the CPP-MR film 204 prior to the deposition of the electrode film 208. If the protective film for the CPP-MR film 204 is made of Ta, the oxide layer on the surface of Ta can be removed by sputter-etching the Ta protective film having a thickness of about 2 nm or more. In order to reduce the contact resistance, the uppermost layer of the CPP-MR film 204 is preferably made of Au or Pt which are originally difficult to form any oxide films. The same effects can be obtained even if a Ta film is provided therebetween in order to improve the concordance to the photoresist, and thereafter, removed by sputter-etching before depositing a top electrode.

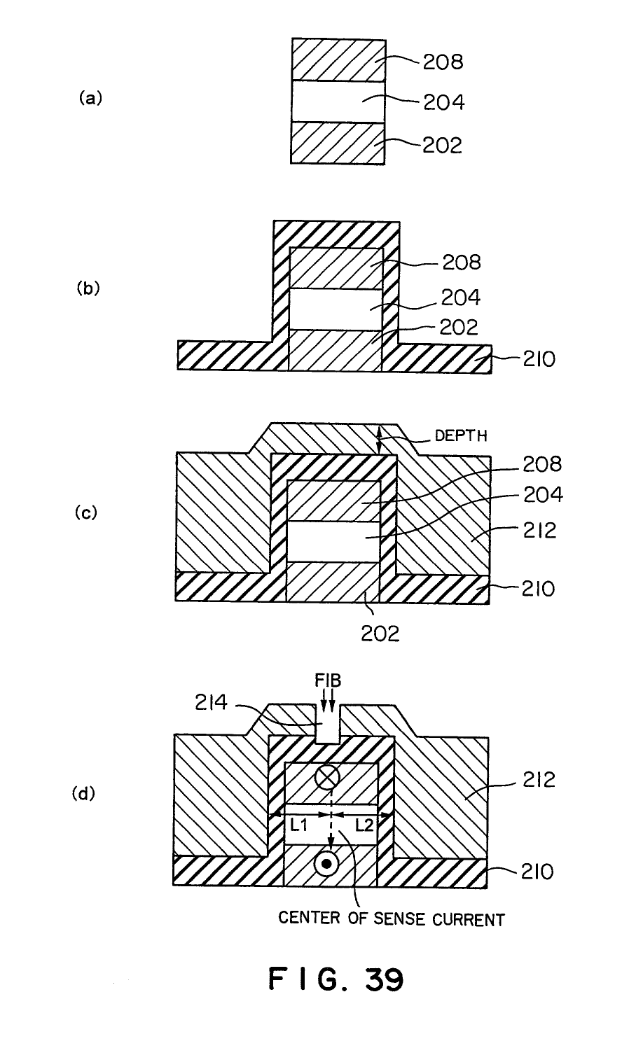

Then, a resist pattern 209 of a photoresist having a width (length in Y directions) of about 0.2 μm is formed on the CPP-MR film 204 and the insulating film 206, and this resist pattern 209 is used as a mask for patterning the electrode film 208, the CPP-MR film 204 and the electrode film 202 to form a stripe-like magnetoresistance effect element (see FIGS. 38(b) and 38(c)). In FIG. 38(c), the reason why the sense currents supplied to the magnetoresistance effect element flow through the stacked electrodes 202 and 208 in different directions is that the magnetic fields generated by the respective sense currents are canceled out. Thus, it is possible to cancel the influence of the magnetic field due to the sense current. FIG. 39(a) shows the cross section of this magnetoresistance effect element which is taken along a plane P shown by a broken line in FIG. 38(c) and which is viewed in a direction of arrow.

Then, as shown in FIG. 39(b), a gap film 210 of, e.g., Si, having a thickness of 20 nm is formed on the magnetoresistance effect element comprising the electrode 202, the CPP-MR film 204 and the electrode 208. Moreover, a magnetic film 212 of, e.g., permalloy, forming a magnetic yoke and having a thickness of 200 nm is formed on the gap film 210, and the magnetic film 212 is flattened until depth (distance to the medium facing surface of the magnetic yoke 212) reaches 50 nm (see FIG. 39(c)).

Then, as shown in FIG. 39(d), a magnetic gap 214 is formed in the magnetic film (magnetic yoke film) 212 using the FIB (Focused Ion Beam). Furthermore, when the magnetic gap 214 is formed, as the accelerating voltage increases, it is possible to carry out a thinner etching, and on the other hand, Ga ions are more deeply doped. For example, it has been reported that Ga ions are doped at an accelerating voltage of 30 KeV to a depth of about 20 nm. If the CPP-MR film 204 exists at this depth, the deterioration of magnetoresistance effect characteristics is caused. Therefore, if the CPP-MR film 204 exists below the magnetic yoke film 212, it is desired that there is a spacing of an FIB over etching depth plus 20 nm or more between the magnetic yoke film 212 and the CPP-MR film 204.

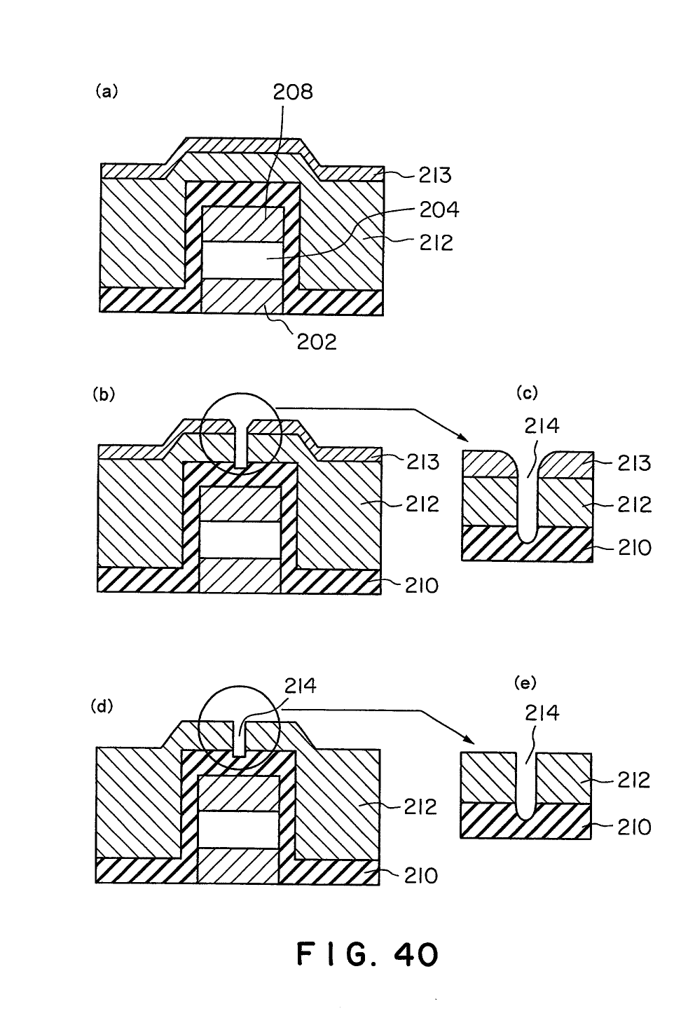

There are some cases where the shape of the magnetic gap 214 on the surface of the magnetic yoke 212 is rounded by the relationship to the beam profile of FIB. In order to form a sharp magnetic gap, the outermost surface of the magnetic yoke 212 is previously coated with a film 213 of another material as shown in FIG. 40(a), and a gap is formed by the FIB (see FIGS. 40(b) and 40(c)), and thereafter, the film 213 of the coating material is removed (see FIGS. 40(b) and 40(e)). Furthermore, for example, the coating material can be removed by The RIE (Reactive Ion Etching) or CDE (Chemical Dry Etching) using a fluorocarbon containing gas after carrying out the FIB using Nb. The coating material may be SiO₂, and beams can be thinned by forming the outermost surface of a metal. In this case, the metal film is removed by the ion milling or RIE, and the SiO₂ film can be removed by the RIE. If no coating material is provided, the edge of the gap formed by the FIB by simply carrying out etching using Ga or an inert gas is sharper than the edge of the gap formed by a so-called gas-assisted FIB etching which carries out etching while supplying a gas, such as iodine, from a nozzle arranged in the vicinity of a processed region. If a chemical assist gas is added, the processing speed increases, but the angle of the shape of the patterned magnetic gap 214 is widened. Therefore, the addition of the chemical assist gas is not desired in order to exhibit the performance of the magnetic gap. However, since a certain kind of mask is non-volatile in the assist gas, if such a coating material is used, the processing speed increases, so that the shape of the processed magnetic gap 214 is sharp. It is advantageous to use Al₂O₃, SiO₂ or Si as the coating material.

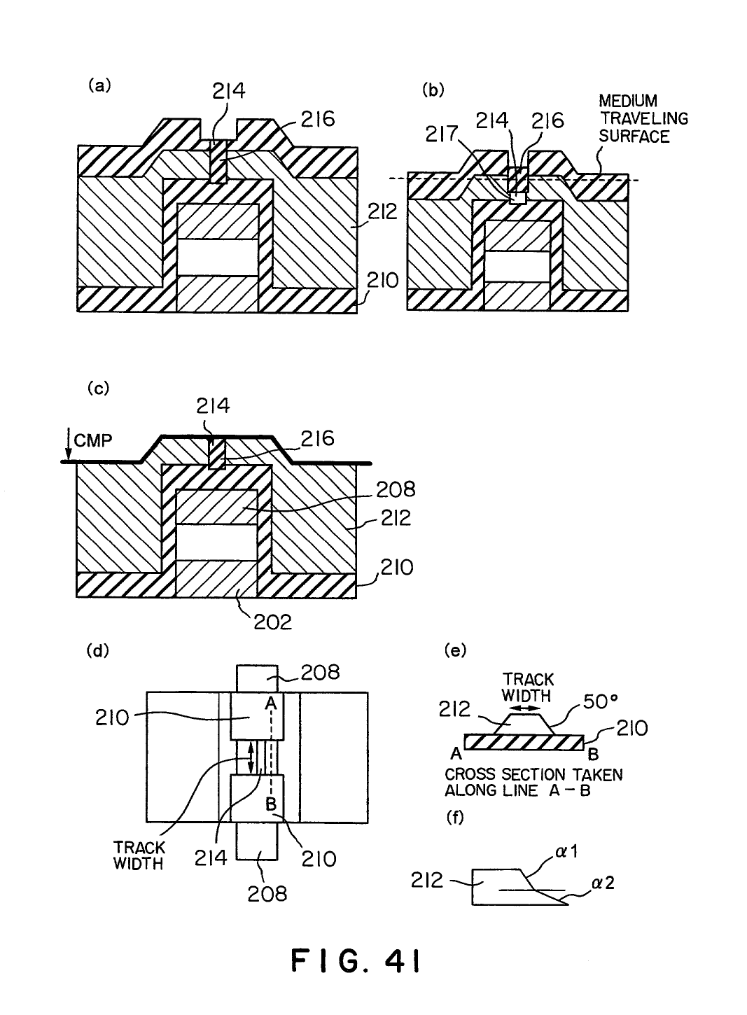

Then, as shown in FIG. 41(a), the gap formed in the magnetic yoke 212 by the FIB is filled with a gap filler 216 of, e.g., SiO₂. For example, the filling is preferably carried out by a good directional method, such as the ion beam sputtering (IBS) method or the cathodic arc method. However,as shown in FIG. 41(b), it is sufficient to finally carry out this filling on the medium traveling surface, and even if a cavity 217 is formed in the FIB processing final end without causing the filling to reach the FIB processing final end, the purpose can be accomplished. Therefore, since it is not required to prepare any special deposition systems for this purpose, it is possible to lower the costs at the gap filling step and the non-defective determining level, so that it is possible to raise yields.

Then, as shown in FIG. 41(c), the surface in which the film 216 of the gap filler has been formed is flattened by the CMP or etch back to expose the surface of the magnetic yoke 212. At this time, the flattening may be excessively carried out so as to exceed the surface of the magnetic yoke 212, so that the surface portion rounded by the FIB gap processing can be polished and removed. In addition,the quantity of magnetic flux flowing into the CPP-MR film 204 can be controlled by controlling the thickness of the magnetic yoke film 212.

Thus, the distances L1 and L2 between a vertical current applying region, i.e., a region shown by a broken line in FIG. 39(d), and the most proximate yokes 212 are equal to each other. Therefore, the influences of the magnetic fields based on sense currents can be equal to each other, so that it is possible to prevent the generation of Barkhausen noises. In addition, the magnetoresistance effect element and the magnetic yokes 212 are formed so as to be self-aligned, so that it is possible to prevent the lowering of yields.

Finally, a processing for defining a track width is carried out using the ion milling. The plan view from the medium traveling surface after this processing is shown in FIG. 41(d), and the cross section taken along line A-B of FIG. 41(d) is shown in FIG. 41(e). The ion milling in the track width processing defines a track width at a photo step, and ion beams are incident at an angle of about 50 degrees (assuming that an angle perpendicular to the substrate is 0 degree) so that the track width edges have tapered angles al and α2 of about 50 to 60 degrees (vertical: 0 degree) as shown in FIG. 41(f). By forming such a shape, it is possible to suppress the reproducing fringing and magnetic domains from being generated in the magnetic yokes 212.

Thirty-First Embodiment

In the above-described thirtieth embodiment, the yoke film 212 is first formed, and the magnetic gap 214 is formed by the FIB. However, there is also a fabricating method for first forming a magnetic gap by patterning, then, depositing a magnetic yoke, and finally, forming a magnetic gap using the flattening means such as the CMP. As the thirty-first embodiment, this fabricating method will be described below.

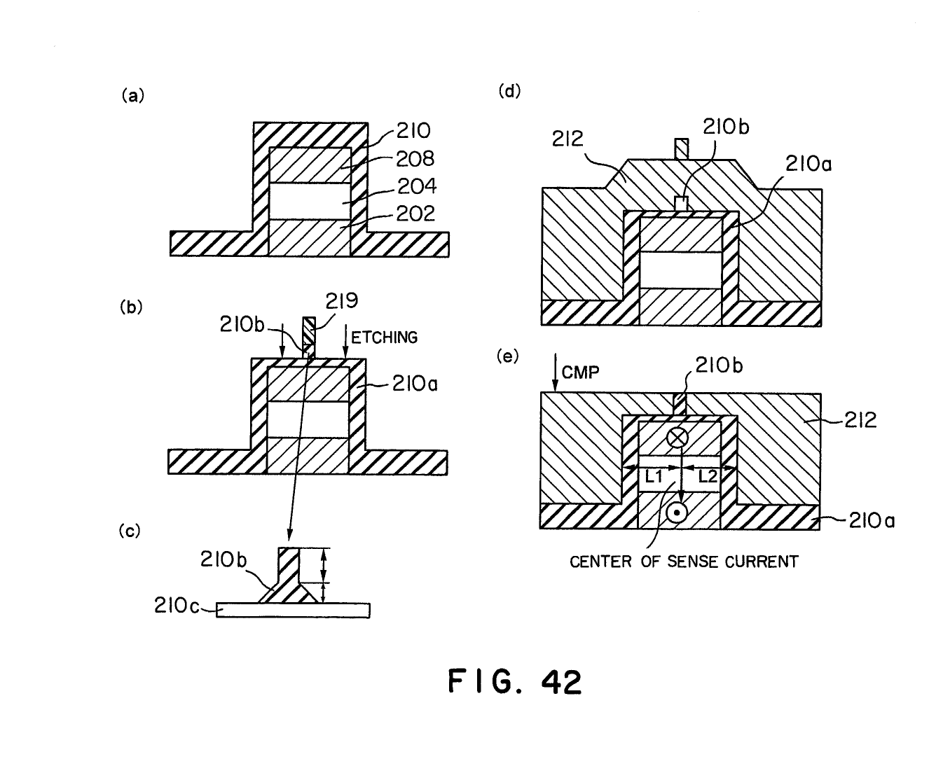

FIG. 42 shows fabricating steps in the thirty-first embodiment of the present invention. As shown in FIG. 42(a), a gap film 210 of, e.g., Si, having a thickness of 70 nm is formed on a magnetoresistance effect element which comprises an electrode film 202, a CPP-MR film 204 and an electrode film 208. An EB (Electron Beam) resist is applied on the gap film 210 to form a resist pattern 219 having a width of 30 nm using an EB exposure system (see FIG. 42(b)). Subsequently, as shown in FIG. 42(b), the resist pattern 219 is used as a mask for etching the gap film 210 by about 60 nm using the RIE using a fluorocarbon containing gas, to form a gap forming portion 210b of the gap film 210. At this time, as shown in FIG. 42(c), etching conditions are varied to form the gap forming portion 210b so that the upper ⅔ portion of the gap forming portion 210b has a tapered angle of 80 to 90 degrees (substantially vertical) and the lower ⅓ portion thereof has a tapered angle of about 45 degrees. If the tapered angles above and below the gap forming portion are thus different, there are two merits. One merit is that the distribution or dispersion in the flattening does not cause the dispersion of the gap width at the flattening step by the CMP after depositing the magnetic yoke 212 since the upper portion is substantially vertical, and the other merit is that the embedded characteristics of the film due to the deposition of the magnetic yoke 212 is better by the lower tapered portion than that if it is vertical. Furthermore, in FIG. 42(c), the gap film 210 is provided with an etching end point layer 210c of, e.g., SiO₂, as a bottom layer. By providing the etching end point layer 210c as an RIE stopper, the gap forming portion 210b can be precisely formed. As one forming method for controlling two-stage tapered angles, the gap forming portion 210b can be formed by causing ion beams to be incident at, e.g., 45 degrees, by the ion milling after the vertical etching by the RIE. In addition, if the gap width is greater than a predetermined width after the gap processing, or if the gap width is intended to be defined to be the EB processing limit or less, the gap can be adjusted to be decreased by causing ion beams to be incident at an angle of 60 to 70 degrees (assuming that an angle perpendicular to the substrate is 0 degree) after processing the gap once. Although the crystallinity of the gap material is destroyed by the incidence of ion beams, it is possible to sufficiently fulfill the function as the gap. If the incident angle of ion beams is a small angle of about 10 degrees, gouging occurs in the vicinity of the gap by Ar particles which are elastic-scattered on the gap, and if the incident angle of ion beams is an angle of 30 to 40 degrees, the etching rate in vertical directions is great. Therefore, there is some possibility that a problem on over etching is caused, and there is some possibility that the gap is gouged out by the influence of Ar ions which are elastic-scattered on the bottom if ion beams are incident at a great angle of about 80 degrees.

Then, a magnetic yoke 212 is deposited so as to cover the gap film 210 and the gap forming portion 210b (see FIG. 42(b)). The magnetic yoke film 212 was formed of an NiFe alloy film using the ion beam sputtering method. The substrate cleaning before deposition was carried out using the ion beam irradiation. If etching is carried out by the RF (Radio Frequency) sputter-cleaning, the temperature of the tip of the gap forming portion 210 tends to be high, and cracks may be produced by thermal stress, so that the etching is preferably carried out at a low power of 1 W/cm² or less. By using the ion beam sputtering for deposition, the directivity of sputtered particles in a direction perpendicular to the substrate is good, and the quality of the magnetic yoke film 212 about the gap is good. The methods for forming the magnetic yoke 212 include a sputtering method which improves the directivity in a direction perpendicular to the substrate (e.g., the long throw type sputter), the cathodic arc method, and the plating method wherein the directivity of incident particles has no problem, in addition to the ion beam sputtering method. If a non-magnetic film is used as a layer underlying the magnetic yoke film 212, the gap length is the sum of the gap forming portion 210b which is formed by etching, and the non-magnetic layer underlying the magnetic yoke films 212 which are formed on both sides of the gap forming portion 210b. Therefore, the gap length can be more strictly controlled by forming the gap width in view of the thickness of the non-magnetic layer underlying the magnetic yoke which is formed on the side of the gap forming portion 210b. In addition, if the gap width is formed so as to be narrower (wider) than a predetermined gap width, the gap width can be adjusted by forming the non-magnetic film underlying the magnetic yoke film 212 so that it is thick (thin). On the other hand, if this underlayer is not required, the etched gap width can be equal to the gap length by using a amorphous magnetic film of CoZrNb or the like as an underlayer. Alternatively, the CoZrNb amorphous film itself can be applied to the yoke film.

Then, as shown in FIG. 42(e), the protruding portion of the gap forming portion 210b on the surface of the magnetic yoke film 212 is flattened by the CMP or the like.

Finally, the track width is processed to obtain the shape shown in FIGS. 41(d) and 41(e). In view of the influence on fringing, it is desired that the side face of the magnetic yoke 212 has a steep slope of an angle α1 on the side of the top face of the magnetic yoke 212 and a gentle slope of an angle α2 on the side of the bottom layer, i.e., it is desired that the relationship of α₁ >α₂ is satisfied. For example, it is preferred that α₁ =30 degrees and α₂ =50 degrees (40 degrees on average). Furthermore, it is assumed that the angle is 0 degree in a direction perpendicular to the substrate.

Also in the fabricating method in the thirty-first embodiment similar to the thirtieth embodiment, it is possible to prevent the lowering of yields and the generation of Barkhausen noises.

Thirty-Second Embodiment

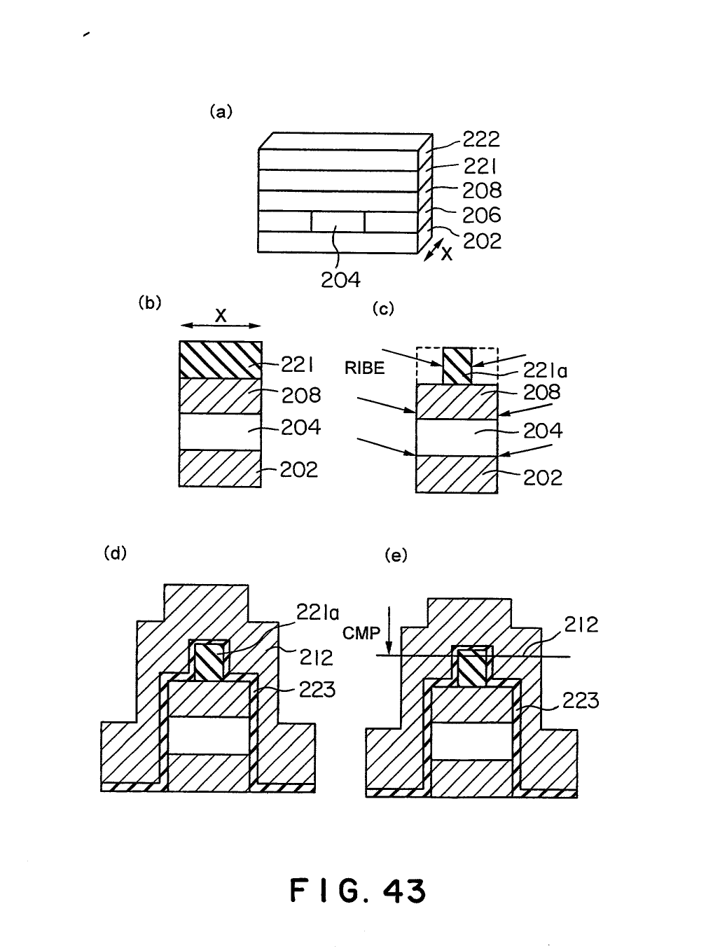

While the width of the element has been 0.1 μm in the thirtieth and thirty-first embodiments, a gap forming method when the width of the element is narrowed to about 0.05 μm will be described as the thirty-second embodiment of the present invention. FIG. 43 shows fabricating steps in the thirty-second embodiment of the present invention.

First, as shown in FIG. 43, if the width x of the element decreases to about 0.05 μm, it is difficult to align a position at which a gap is to be formed. In that case, the bottom element/electrode stack is aligned by the following method. As shown in FIG. 43(a), a film 221 of a gap material of, e.g., Si, having a width of x=0.05 μm is formed on a magnetoresistance effect element comprising an electrode film 202, a CPP-MR film 204 and an electrode film 208. Then, a resist pattern 222 of a photoresist is formed on the film 221, and the resist pattern 222 is used as a mask for patterning the film 221 and the magnetoresistance effect element (see FIG. 43(a) ). The cross section after patterning and removing the resist pattern 222 is shown in FIG. 43(b).

Subsequently, as shown in FIG. 43(c), etching is carried out at an angle of 70 degrees in a direction perpendicular to the substrate, with a fluorocarbon containing gas using an RIBE (Reactive Ion Beam Etching) system. The etching is carried out from both sides so that a gap forming portion 221a of the film 221 has a predetermined width (see FIG. 43(c)).

Then, after etching so that the width of the gap forming portion 221a is a predetermined width, an insulating film 223 is formed so as to cover the magnetoresistance effect element and the gap forming portion 221a and a magnetic yoke film 212 is formed so as to cover the insulating film 223, as shown in FIG. 43(d). Subsequently, as shown in FIG. 43(e), the magnetic yoke film 212 is flattened by the CMP or the like to exposure the gap forming portion 221a to the medium traveling surface. In this case, the sum of the thickness of the gap forming portion 221a and the thickness of the insulating film 223 is a gap length (see FIG. 43(e)).

Also in the fabricating method in the thirty-second embodiment similar to the thirtieth embodiment, it is possible to prevent the lowering of yields and the generation of Barkhausen noises.

Thirty-Third Embodiment

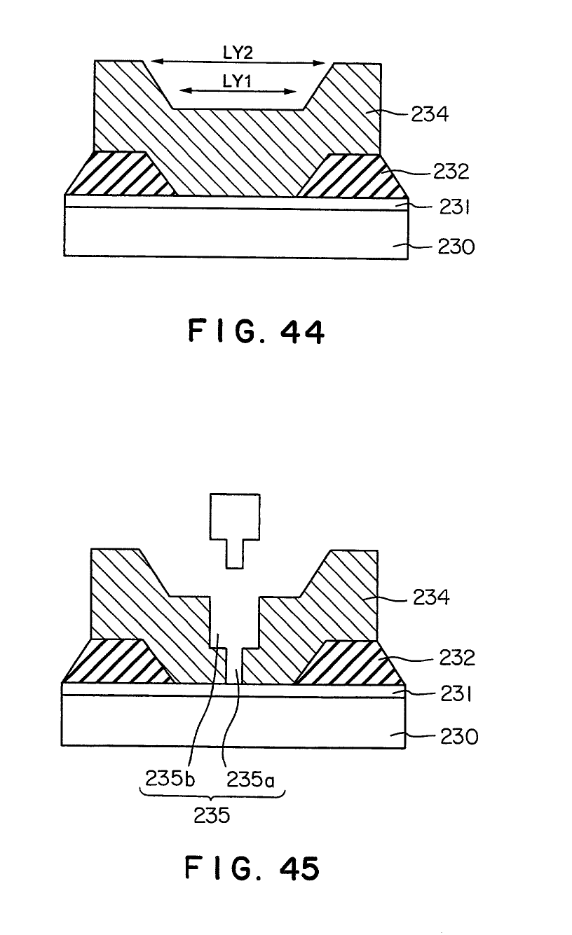

Referring to FIGS. 44 to 57, the thirty-third embodiment of a fabricating method according to the present invention will be described below. While the magnetic yoke has been formed after forming the magnetoresistance effect element in the above described thirtieth to thirty-second embodiments, the fabrication method in this embodiment is a fabricating method for forming a magnetoresistance effect element after forming a magnetic yoke.

First, as shown in FIG. 44, a DLC (Diamond Like Carbon) film 231 having a thickness of 2 nm is formed on a substrate 30 of, e.g., Si. This DLC film 231 is the surface of the Si substrate 230, so that the DLC film 231 can be thin since it is not required to provide any underlayers of Si. In the deposition of the DLC film 231, the FCVA (Filtered Cathodic Vacuum Arc) method was adopted. Since the surface of the substrate 230 does not basically have irregularities, wraparound is required for the DLC film 231. Therefore, this method is advantageous to a forming method in high vacuum, such as the FCVA. Of course, the CVD method or the sputtering method may be used. Then, as shown in FIG. 44, an insulating film 232 of, e.g., SiOₓ, having a thickness of 100 nm is deposited, and an etching step of defining a track width is carried out to form a trench in the insulating film 232 to define the track width by this trench. By controlling the angle of this trench, the magnetic domain structure of the magnetic yoke can be controlled. The angle is preferably in the range of from 40 to 60 degrees. The roughness of the trench surface is preferably controlled so as to be about 5 nm. Thus, it is possible to prevent the generation of the magnetic domain due to the rough surface. In addition, the bias effect to the magnetic yoke can be expected by applying PtMn or a synthetic ferri layer in place of SiOₓ. Then, as shown in FIG. 44, a film of, e.g., CoZnNb, having a thickness of 5 nm as an underlayer and a film of, e.g., NiFe, having a thickness of 100 nm are continuously formed to form a magnetic yoke film 234. In order to make the magnetic characteristics of a crystalline film, such as NiFe, good on an amorphous film, such as the DLC film 231, an underlayer is required. The non-magnetic film itself of Ta or the like generally used is a magnetic spacing, so that the spacing is widened. Therefore, at a flying height of less than 20 nm at which the spacing of 5 nm of the non-magnetic underlayer has an influence on regenerative signals, a magnetic underlayer of CoZrNb or the like is effective. If a non-magnetic film is used as the underlayer, the magnetic track width substantially decreases by twice as large as the thickness of the film. Therefore, the trench width must be wide by that decreased width. The filling of the trench with the magnetic film is preferably carried out by a method by which the directivity of flying magnetic particles is high, e.g., the ion beam sputtering, the long throw, the cathodic arc method, a sputtering using an operation exhaust system, or a plating method. Unlike the shielded head, the initial growth layer contributes to magnetic yoke characteristics very much, so that it is important to carry out a deposition method wherein the underlayer and directivity are high.

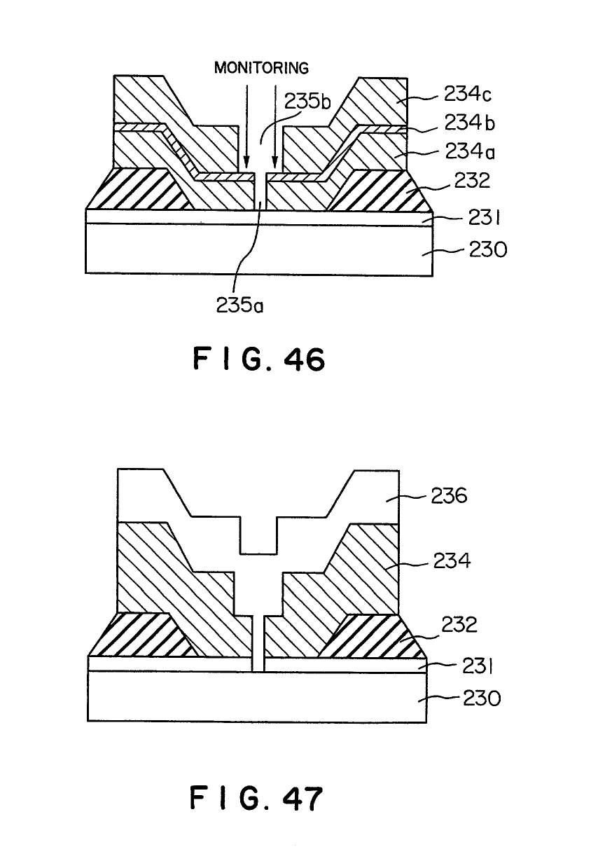

Then, as shown in FIG. 45, the irregularities produced by the trench are used as targets to form a hole 235 in the magnetic yoke 234 using the FIB (Focused Ion Beam). A portion 235a of this hole 235 on the surface of the substrate defines a magnetic gap length, and a widened portion 235b above the portion 235a defines aback gap. From the stand point of the suppression of the magnetic domain, the magnetic gap 235a and the back gap 235b are preferably continuously connected to each other without any corners. As shown in FIG. 46, a magnetic material 234b of, e.g., CoZrNb, may be sandwiched in the connection region between the back gap 235b and the magnetic gap 235a to form an FIB processed end point monitor. Furthermore, in FIG. 46, reference numbers 234a and 234c denote a film of, e.g., NiFe. In this case, the films 234a 234b and 234c constitute the magnetic yoke 234.

Then, as shown in FIG. 47, the back gap 235b and magnetic gap which are formed by the FIB are filled with a non-magnetic material of, e.g., Cu. In this case, similar to the above described filling deposition of the yoke magnetic material, a deposition method having a good directivity, such as the ion beam sputtering, or a plating method are preferably carried out.

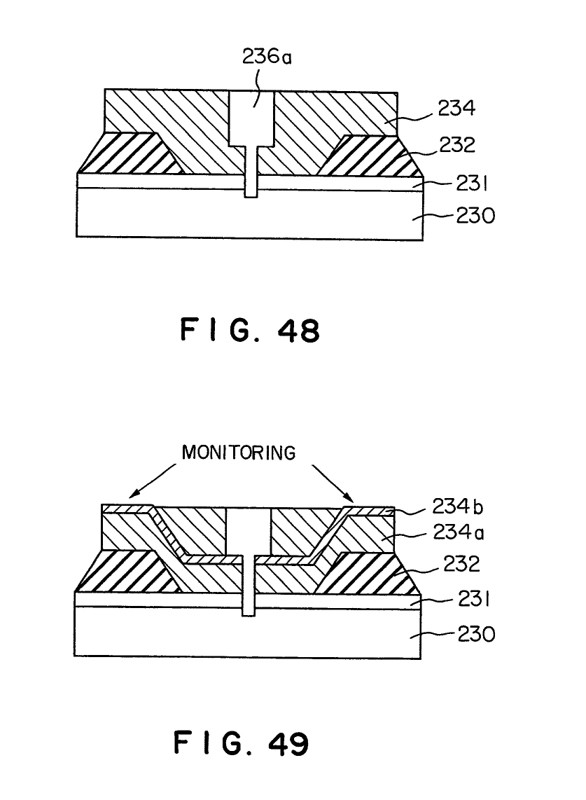

Then, as shown in FIG. 48, the filled surface is flattened by a technique, such as the CMP. In this case, as shown in FIG. 49, a magnetic film 234b of CoZrNb or the like for the monitoring of the end point of planarization may be sandwiched at that depth during the deposition of the yoke film. This magnetic film 234b can be monitored from a waste polishing liquid during the CMP. Furthermore, if the CMP is carried out at the step shown in FIG. 48, a difference in level between the non-magnetic material of Cu and the magnetic yoke film 234 of NiFe is produced by dishing as shown in FIG. 50. In this embodiment, a difference in level of about 30 nm is produced by dishing.

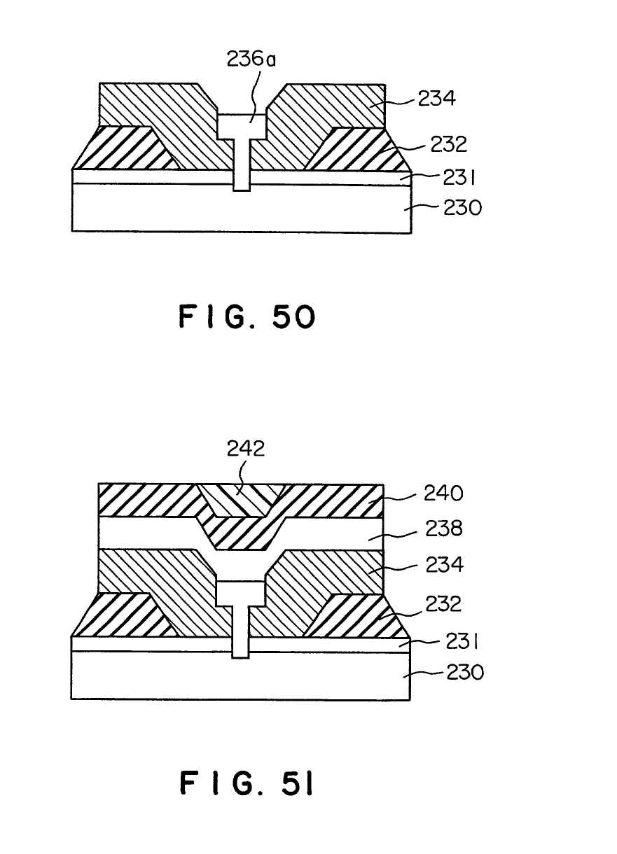

Then, as shown in FIG. 51, a CPP-MR film 238 is deposited on the magnetic yoke 234 and the non-magnetic material 236a, and a film 240 of, e.g., SiOₓ, is deposited on the CPP-MR film 238 for the purpose of transfer of the difference in level. Moreover, a low molecular weight polymer 242 is applied on the film 240, and the surface thereof is flattened. This polymer 242 is etched back by the RIE or the like to leave the polymer 242 only in a dishing hole as shown in FIG. 51 (see FIG. 51). This polymer 242 is used as a mask for carrying out the RIE, and the ion milling is carried out to pattern CPP-GMR only in the hole. Thus, it is possible to leave the CPP-GMR only on the portion of the back gap 235b while carrying out self-alignment. Therefore, it is not required to take account of the alignment error and patterning size error between the back gap 235b the magnetic gap 235a and the CPP-GMR film 238.

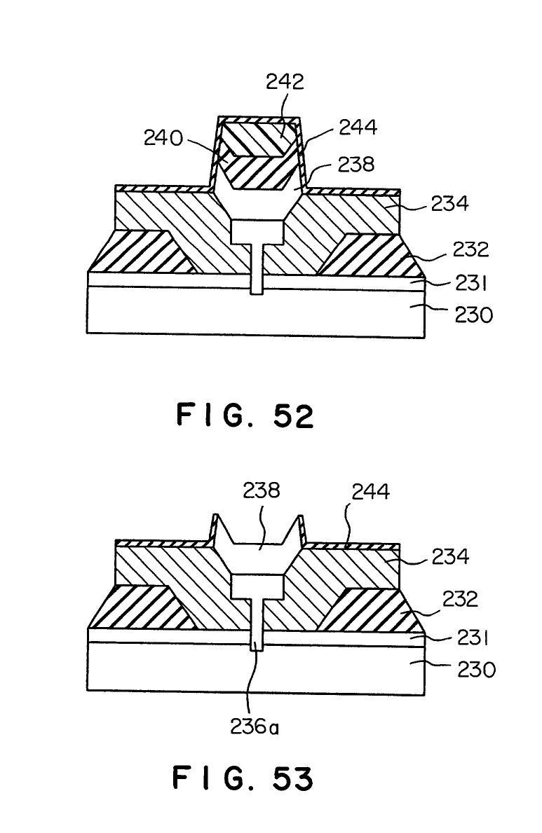

Then, as shown in FIG. 52, an insulating film 244 of, e.g., alumina (Al₂O₃), having a thickness of 30 nm is formed on the whole surface. Thereafter, as shown in FIG. 53, the insulating film 244 on the resist 242 is lifted off or removed using polishing.

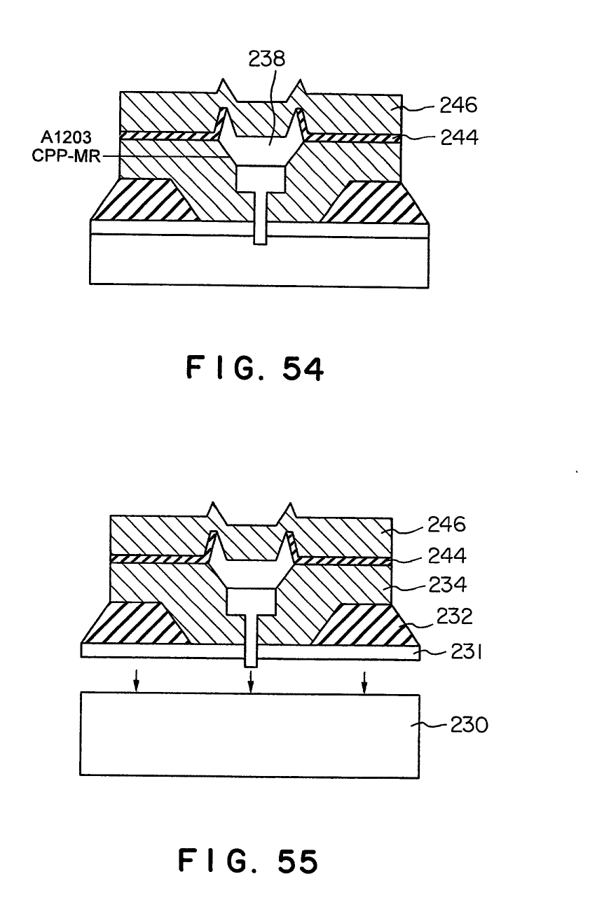

Finally, as shown in FIG. 54, an electrode film 246 is formed on the whole surface to complete the wafer step. Before forming the electrode film 246, it is required to take notice of an etching step of removing the oxide layer of the cap layer (uppermost layer) of the CPP-MR film 238. Since the element size of the CPP-MR film 238 is a very small size of about 0.1 μm, the influence of the residual oxide layer in that portion on the contact resistance is very great. Therefore, before forming the electrode film 246, it is required to design the thickness of the cap layer and the thickness of the alumina protective film 244 so as to sufficiently carry out the sputter etching and ion beam etching. If the thickness of the cap layer is set to be great in order to prevent the CPP-MR film 238 from being damaged by etching irradiation, the yoke is strongly biased by the magnetic field based on the vertical application of a current. Therefore, it is not desired that the cap layer is thick. For that reason, the cap layer is preferably formed of a material of Au or Pt from which any oxide layers are basically formed, or Ta and Au or Pt are preferably stacked.

Then, the Si substrate 230 used at the wafer step is peeled off by the back grinding and the wet etching or the torch using a CF₄ containing gas (see FIG. 55). At this time, by fixing the surface of the wafer by a support substrate, it is easy to prevent the sample from being damaged by the subsequent handling. In addition, the peeling-off of the substrate by the CF₄ containing gas torch is a more reliable method than the wet etching, since the yoke material and the gap filler are not basically etched. In that case, it is not required to first coat the DLC film 231.

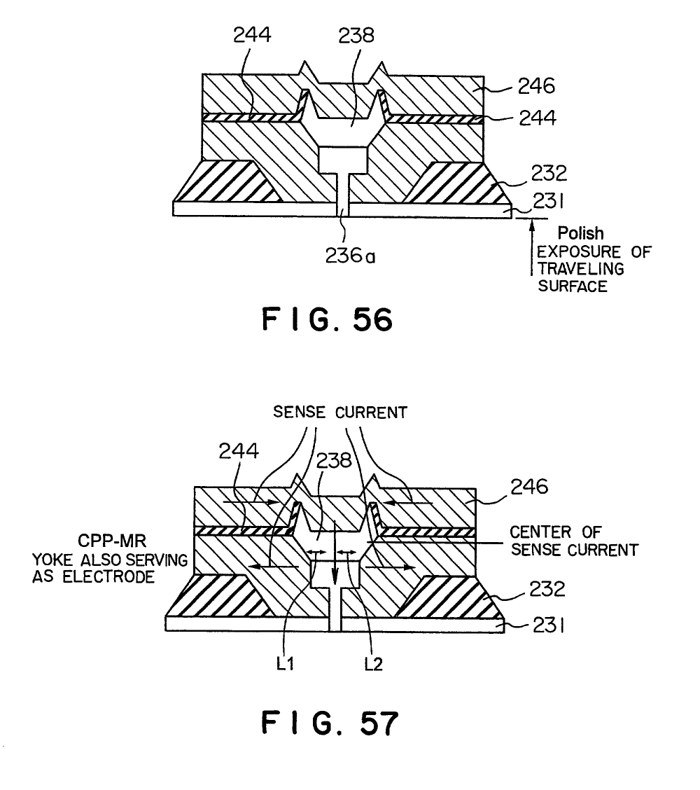

Then, as shown in FIG. 56, the gap material 236a which is coated with the CLC film 231 and which protrudes toward the medium traveling surface is removed by the flattening method, such as the CMP. As described above, the DLC film 231 having been formed at the first time may be formed after the flattening step. Thus, it is possible to more strictly control the thickness of the head protective film.

The sample was thus prepared. At a result, as shown in FIG. 57, with respect the sense current flowing from the electrode 246 to the magnetic yoke film 234 also serving as an electrode via the CPP-MR film 238, the center of the sense current in vertical directions in the CPP-MR film 238 is spaced from the proximate yoke positions by the same distances of L1 and L2. As a result, the galvano magnetic field based on the vertically applied sense current is similarly applied on both sides.

The yoke type magnetic head fabricated by the fabricating method in this thirty-third embodiment can also prevent the lowering of yields and the generation of Barkhausen noises.

As described above, in the twenty-ninth through thirty-third embodiments, one of the electrodes is formed in the magnetic gap. Therefore, since the magnetic gap between the magnetoresistance effect film and the magnetic yoke can be smaller than that in conventional magnetic head, or since the magnetic gap can be omitted, the flow of a magnetic flux into the magnetoresistance effect film can be smooth, i.e., reluctance in a magnetic circuit formed by the magnetic yoke and the magnetoresistance effect film can be lowered, so that it is possible to prevent the lowering of the magnetic flux efficiency.

Thirty-Fourth Embodiment

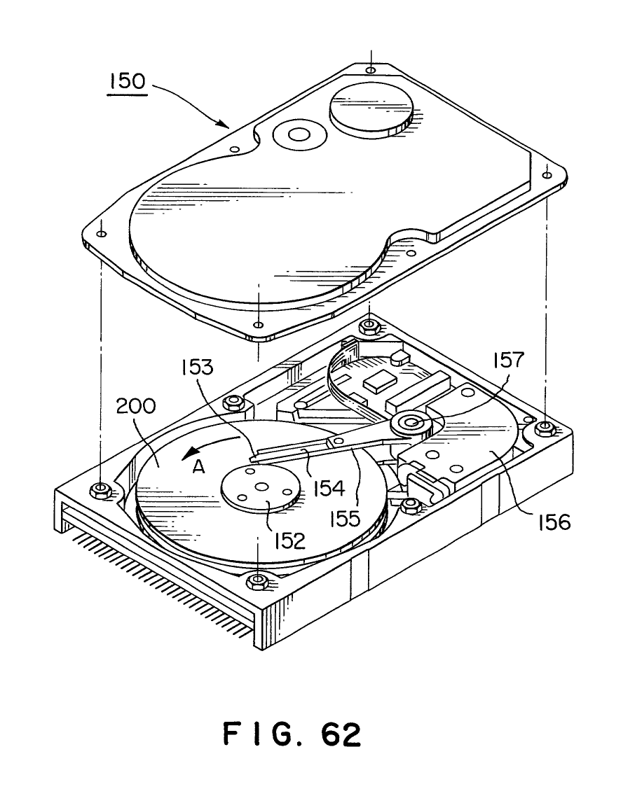

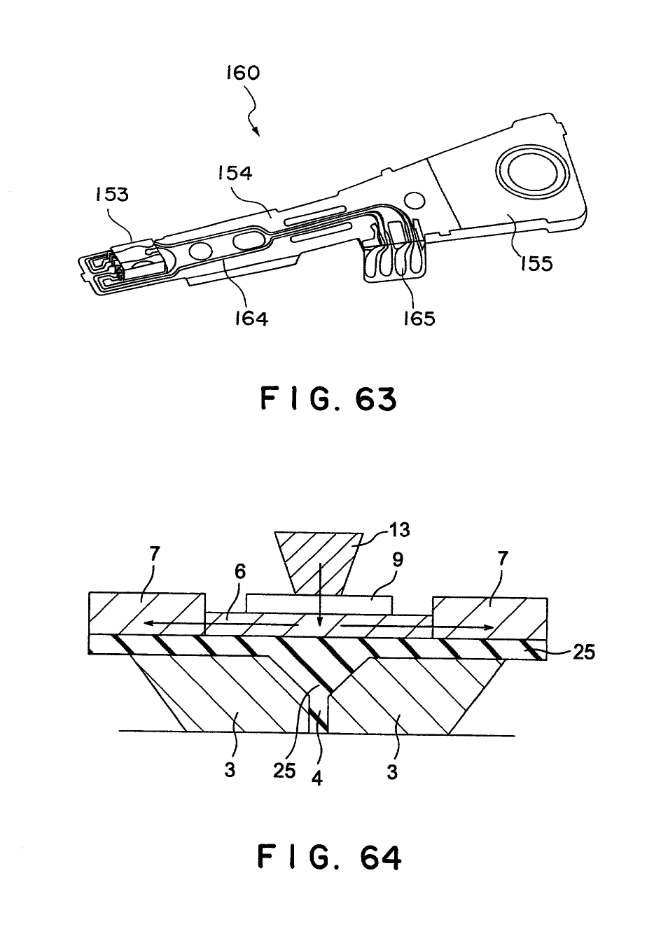

Referring to FIGS. 62 and 63, the thirty-fourth embodiment of the present invention will be described below. This embodiment relates to a magnetic disk unit. The schematic construction of this magnetic disk unit is shown in FIG. 62. That is, the magnetic disk unit 150 in this embodiment is a unit of a type in which a rotary actuator is used. In FIG. 62, a magnetic disk 200 is mounted on a spindle 152, and is rotated in a direction of arrow A by means of a motor (not shown) which responds to a control signal from a drive unit control part (not shown). A head slider 153 for recording/reproducing information stored in the magnetic disk 200 is mounted on the tip of a thin-film-like suspension 154. For example, a magnetic head in any one of the above-described embodiments is provided in the vicinity of the head slider 153.

If the magnetic disk 200 rotates, the medium facing surface (ABS (Air Bearing Surface)) of the head slider 153 is held at a predetermined flying height from the surface of the magnetic disk 200.

The suspension 154 is connected to one end of an actuator arm 155 which has a bobbin portion or the like for holding a driving coil (not shown). On the other hand of the actuator arm 155, a voice coil motor 156 which is a kind of a linear motor is provided. The voice coil motor 156 comprises: a driving coil (not shown) wound onto the bobbin portion; and a magnetic circuit comprising permanent magnets, which are arranged so as to face each other via the coil, and facing yokes.

The actuator arm 155 is held by two ball bearings (not shown) which are provided above and below a fixing shaft 157, and is rotatable and slidable by means of the voice coil motor 156.

FIG. 63 is an enlarged perspective view of a magnetic head assembly in front of an actuator arm 155, which is viewed from the side of a disk. That is, the magnetic head assembly 160 has an actuator arm 151 having, e.g., a bobbin portion or the like for holding a driving coil, and a suspension 154 is connected to one end of the actuator arm 155.

A head slider 153 having a magnetic head described in any one of the above described embodiment is mounted on the tip of the suspension 154. Furthermore, a reproducing head and a recording head may be combined. The suspension 154 has a lead wire 164 for writing and reading signals. This lead wire 164 is electrically connected to each electrode of the magnetic head which is incorporated in the head slider. In FIG. 63, reference number 165 denotes an electrode pad of the magnetic head assembly 160.

Between the medium facing surface (ABS) of the head slider 153 and the surface of the magnetic disk 200, a predetermined flying height is set.

Furthermore, the magnetic disk unit may be a magnetic disk unit for carrying out only regeneration, or a magnetic disk unit for carrying out recording and regeneration. In addition, the medium should not be limited to a hard disk, but all of other magnetic recording medium, such as flexible disks and magnetic cards, may be used. Moreover, the magnetic disk unit may be a so-called “removable” type unit wherein a magnetic recording medium is removed from the unit.

As described above, according to the present invention, it is possible to prevent the lowering of the magnetic flux efficiency.

While the present invention has been disclosed in terms of the embodiment in order to facilitate better understanding thereof, it should be appreciated that the invention can be embodied in various ways without departing from the principle of the invention. Therefore, the invention should be understood to include all possible embodiments and modification to the shown embodiments which can be embodied without departing from the principle of the invention as set forth in the appended claims.

What is claimed is:

1. A yoke type magnetic head comprising:
a magnetoresistance effect film sensing a signal magnetic field from a medium;
a pair of magnetic yokes being magnetically connected to said magnetoresistance effect film and facing each other via a magnetic gap; and
a pair of electrodes being connected to said magnetoresistance effect film so that a sense current in a thickness direction of said magnetoresistance effect film is applied thereto, one of said electrodes being formed in said magnetic gap.

2. A yoke type magnetic head as set forth in claim 1, wherein each of said pair of magnetic yokes has a flat portion which faces said magnetic gap and which is substantially parallel to a medium facing surface, and said magnetoresistance effect film is formed on a plane which is substantially parallel to said medium facing surface.

3. A yoke type magnetic head as set forth in claim 1, wherein said magnetoresistance effect film is a current perpendicular to plane type giant magnetoresistance effect film.

4. A yoke type magnetic head as set forth in claim 1, wherein said magnetoresistance effect film is a tunneling magnetoresistance effect film.

5. A yoke type magnetic head as set forth in claim 1, wherein said magnetic yokes are electrically connected to said electrode formed in said magnetic gap.

6. A yoke type magnetic head comprising:
a magnetoresistance effect film, formed on a plane substantially parallel to a medium facing surface, sensing a signal magnetic field from a medium;
a pair of magnetic yokes facing each other via a magnetic gap, each of said pair of magnetic yokes having a flat portion which faces said magnetic gap and which is substantially parallel to a medium facing surface, said pair of magnetic yokes being electrically connected to said magnetoresistance effect film; and
a pair of electrodes which are electrically connected to said magnetoresistance effect film,
said magnetic yokes being magnetically and electrically connected to said magnetoresistance effect film, and said magnetic yokes also serving as one of said pair of electrodes.

7. A yoke type magnetic head as set forth in claim 6, wherein said magnetoresistance effect film is formed so that a sense current in a thickness direction of said magnetoresistance effect film is applied thereto.

8. A yoke type magnetic head as set forth in claim 7, wherein a non-magnetic electric conductor is formed in said magnetic gap, and said electric conductor is electrically connected to said magnetic yokes also serving as said electrode.

9. A yoke type magnetic head as set forth in claim 8, wherein said magnetic yokes also serving as said electrode are electrically grounded.

10. A yoke type magnetic head as set forth in claim 9, wherein said magnetoresistance effect film is a current perpendicular to plane type giant magnetoresistance effect film.

11. A yoke type magnetic head as set forth in claim 9, wherein said magnetoresistance effect film is a tunneling magnetoresistance effect film.

12. A yoke type magnetic head comprising:
a magnetoresistance effect film sensing a signal magnetic field from a medium;
first and second magnetic yokes being magnetically connected to said magnetoresistance effect film and facing each other via a magnetic gap; and
first and second electrodes being connected to said magnetoresistance effect film so that a sense current in a thickness direction of said magnetoresistance effect film is applied,
said magnetoresistance effect film being formed so as to straddle said magnetic gap,
said first electrode having a flat surface on the side of said magnetoresistance effect film,
a contact area of said first electrode with said magnetoresistance effect film being defined by the area of said magnetoresistance effect film, and
the area of said flat surface being greater than said contact area.

13. A yoke type magnetic head as set forth in claim 12, wherein said magnetoresistance effect film comprises a free layer, a pin layer, an antiferromagnetic layer for fixing magnetization of said pin layer, an underlayer, a cap layer and a spacer layer which is sandwiched between said pin layer and said free layer.

14. A yoke type magnetoresistance effect head as set forth in claim 13, wherein the area of each of at least said pin layer, said antiferromagnetic layer and said cap layer is defined so as to be smaller than the area of said free layer, and
said pin layer, said cap layer and said antiferromagnetic layer are formed on said magnetic gap.

15. A yoke type magnetic head as set forth in claim 12, wherein each of said first and second magnetic yokes includes a tip portion having a flat portion which faces said magnetic gap and which is substantially parallel to said medium facing surface, and a wing portion extending from a portion which is provided between said tip portion and said magnetoresistance effect film,
the area of said flat portion of said magnetic yokes being smaller than the cross-sectional area of an arbitrary cross section of said magnetic yokes which are substantially parallel to a medium facing surface,
said magnetic gap being formed between said medium facing surface and the formed surface of said magnetoresistance effect film,
the size of said magnetic gap on the side of the formed surface of said magnetoresistance effect film being greater than the size of said magnetic gap on the side of said medium facing surface, and
the formed surface of said magnetoresistance effect film being substantially parallel to said medium facing surface.

16. A yoke type magnetic head as set forth in claim 13, wherein a center of a medium facing surface of said magnetic gap is a center of a coordinate axis, an axis extending in a track cross direction from the center of the coordinate axis is X-axis, an axis extending in a bit length direction from the center of the coordinate axis is Y-axis, the length of said pin layer in the track cross direction is Wp, the length of said pin layer in the bit length direction is Lp, the length of said magnetic yoke on the side of the medium facing surface in the X-axis direction is Wy1, the length of said magnetic yoke on the side of the formed surface of said magnetoresistance effect film in the X-axis direction is Wy3, and the length of the tip portion of said magnetic yoke on the side of the formed surface of said magnetoresistance effect film in the Y-axis direction is Ly2,
an end portion of said pin layer in the track cross direction, which has an x-coordinate expressed by x=±Wp/2, is defined in a region which is beyond a range of an end portion of said tip portion of said magnetic yoke, which has an x-coordinate expressed by x=±(Wy1) /2, and which is within a range of an end portion of said magnetic yoke layer in the track cross direction, which has an x-coordinate expressed by x=±(Wy3) /2, and
an end portion of said pin layer in the bit length direction, which has a y-coordinate expressed by y=±Lp/2, is defined in a region which is within a range of the end portion of the tip portion of said magnetic yoke, which has a y-coordinate expressed by y=±(Ly2)/2.

17. A yoke type magnetic head as set forth in claim 13, wherein a center of a medium facing surface of said magnetic gap is a center of a coordinate axis, an axis extending in a track cross direction from the center of the coordinate axis is X-axis, an axis extending in a bit length direction from the center of the coordinate axis is Y-axis, the length of said free layer in the track cross direction is Wf, the length of said free layer in the bit length direction is Lf, and the lengths of said tip portion of said magnetic yoke on the side of the formed portion of said magnetoresistance effect film in the X and Y directions are Wy2and Ly2, respectively,
an end portion of said free layer in the track cross direction, which has an x-coordinate expressed by x=±Wf/2, is defined in a region which is beyond a range of x=+(Wy2)/2, and the end portion of said free layer in the bit length direction, which has a y-coordinate expressed by y=±Lf/2, is defined in a region which is beyond a range of y=±Ly2/2.

18. A yoke type magnetic head as set forth in claim 15, wherein said magnetoresistance effect film is electrically connected to said first and second magnetic yoke, and
said second electrode is electrically connected to said magnetic yokes.

19. A yoke type magnetic head as set forth in claim 13, wherein said bottom electrode is formed so as to be electrically connected to said free layer.

20. A magnetic disk unit including a yoke type magnetic head as set forth in claim 1.
